(19) United States
(12) Patent Application Publication
(10) Pub. No.: US 2026/0028195 A1
(43) Pub. Date: Jan. 29, 2026

(54) SYSTEM WITH PLURALITY OF TRAVEL PATHS FOR STACKING CONSUMER PRODUCTS, AND METHOD OF STACKING THEREOF

(71) Applicant: Altria Client Services LLC, Richmond, VA (US)

(72) Inventors: James D. EVANS, Chesterfield, VA (US); Thien NGUYEN, Glen Allen, VA (US); Sean P. SUNDBERG, Richmond, VA (US)

(73) Assignee: Altria Client Services LLC, Richmond, VA (US)

(21) Appl. No.: 19/276,146

(22) Filed: Jul. 22, 2025

Related U.S. Application Data
(60) Provisional application No. 63/675,930, filed on Jul. 26, 2024.

(51) Int. Cl. B65G 57/32; A24F 23/00; B65G 47/44; B65G 47/68; B65G 47/69; B65G 47/84; B65G 57/09

(52) U.S. Cl. CPC B65G 57/32; B65G 47/44; B65G 47/682; B65G 47/69; B65G 47/846; B65G 57/09; A24F 23/00

(57) ABSTRACT

The system includes a plurality of travel paths for conveying consumer products, the travel paths being in a side-by-side configuration, each one of the plurality of travel paths having a discharge point at a unique elevation, and a first wheel defining a first set of cutouts around a periphery of the first wheel, the first wheel being configured to rotate in a horizontal plane as each one of the first set of cutouts accepts one of the consumer products from each of the plurality of travel paths, in a successive order as the first set of cutouts pass in front of the discharge points, in order to form stacks of the consumer products in each of the first set of cutouts.

### CROSS-REFERENCE TO RELATED APPLICATION

This application claims the priority benefit of U.S. Provisional Application No. 63/675,930 filed on Jul. 26, 2024, the entire contents of which are incorporated herein by reference.

### BACKGROUND

### Field

Example embodiments generally relate to a system for stacking consumer products.

### Description of Related Art

Consumer products can be packaged together for distribution and/or sale.

### SUMMARY

At least one example embodiment is directed toward a system.

In at least one example embodiment, the system includes a plurality of travel paths for conveying consumer products, the travel paths being in a side-by-side configuration, each one of the plurality of travel paths having a discharge point at a unique elevation; and a first wheel defining a first set of cutouts around a periphery of the first wheel, the first wheel being configured to rotate in a horizontal plane as each one of the first set of cutouts accepts one of the consumer products from each of the plurality of travel paths, in a successive order as the first set of cutouts pass in front of the discharge points, in order to form stacks of the consumer products in each of the first set of cutouts.

In at least one example embodiment, each one of the plurality of travel paths includes a chute that is at least partially defined by a feed tray, and each of the chutes is in the side-by-side configuration, a distal end of the chutes branching into the discharge points at the unique elevation.

In at least one example embodiment, each one of the chutes are further defined at least in part by a first structure on a first conveyor, the first structure being configured to discharge the consumer products into the feed tray.

In at least one example embodiment, the first wheel is configured to accept one of the consumer products from each one of the plurality of travel paths at a same time.

In at least one example embodiment, an elevation of each one of the discharge points incrementally increases, from a first discharge point of a first travel path to a last discharge point of a last travel path, of the plurality of travel paths, the first wheel being configured to rotate in a direction that causes each of the first set of cutouts to pass in front of the discharge points in the successive order from the first discharge point to the last discharge point.

In at least one example embodiment, the first wheel is configured to discharge the stacks of the consumer products from each one of the first set of cutouts once a first number of the consumer products in each of the stacks equals a second number of the plurality of travel paths.

In at least one example embodiment, the first number and the second number equal five.

In at least one example embodiment, the system further includes a second conveyor adjacent to the first wheel, the second conveyor including holders, each one of the holders being configured to receive one of the stacks from a respective one of the first set of cutouts of the first wheel at a first unloading location.

In at least one example embodiment, the second conveyor is configured to transport the stacks in the holders from the first unloading location to a second unloading location, the second conveyor and the holders being configured to discharge the stacks at the second unloading location.

In at least one example embodiment, the second conveyor is configured change an orientation of each one of the holders from an upright orientation to at least one of a tilted orientation or an upside-down orientation at the second unloading location.

In at least one example embodiment, the second conveyor is configured to convey each one of the holders in an upside-down orientation during at least some of a travel distance as the second conveyor conveys the holders from the second unloading location back the first unloading location.

In at least one example embodiment, each one of the holders includes a discharge device that is configured to at least partially assist in discharging one of the stacks of the consumer products from the holder at the second unloading location.

In at least one example embodiment, each one of the holders includes guards that vertically extend from a base of the holder, the guards being configured assist in holding a first stack, of the stacks of the consumer products, on the base.

In at least one example embodiment, the guards are configured to be actuated from a first position to a second position, the first position causing the guards to grip the first stack, the second position causing the guards to be either separated or tilted away from the first stack.

In at least one example embodiment, the system further includes a second wheel adjacent to the first wheel, the second wheel defining a second set of cutouts around a periphery of the second wheel, the second wheel being configured to rotate in the horizontal plane, the system being configured to discharge each one of the stacks of the consumer products from one of the first set of cutouts to one of the second set of cutouts.

In at least one example embodiment, the first wheel rotates in a first rotational direction that is one of a clockwise or a counter-clockwise direction, and the second wheel rotates in a second rotational direction that is opposite the first rotational direction.

In at least one example embodiment, the first wheel has a first diameter and the second wheel has a second diameter, the first diameter being larger than the second diameter.

In at least one example embodiment, the first wheel rotates at a first rotational speed and the second wheel rotates at a second rotational speed, the first rotational speed being slower than the second rotational speed.

In at least one example embodiment, the system further includes a second conveyor adjacent to the second wheel, the second conveyor including holders, each one of the holders being configured to receive one of the stacks from a respective one of the second set of cutouts of the second wheel at a first unloading location.

In at least one example embodiment, the second conveyor is configured to transport the stacks in the holders from the first unloading location to a second unloading location, the second conveyor and the holders being configured to discharge the stacks at the second unloading location.

In at least one example embodiment, each one of the holders includes guards that vertically extend from a base of the holder, the guards being configured assist in holding a first stack, of the stacks of the consumer products, on the base.

In at least one example embodiment, the guards are configured to be actuated from a first position to a second position, the first position causing the guards to grip the first stack, the second position causing the guards to be either separated or tilted away from the first stack.

In at least one example embodiment, the first set of cutouts are at least partially conformed to a shape of a side of one of the stacks of the consumer products.

In at least one example embodiment, the first set of cutouts are at least partially conformed to a shape of a side of one of the stacks of the consumer products, each one of the stacks being cylindrical in shape.

In at least one example embodiment, the system further includes the consumer products, each one of the consumer products including a cylindrically-shaped canister.

In at least one example embodiment, the system further includes a heat tunnel at least partially covering the second conveyor, the heat tunnel being configured to apply heat to the stacks as the second conveyor conveys the holders on the second conveyor.

In at least one example embodiment, each one of the holders includes guards that vertically extend from a base of the holder, the guards being configured assist in holding a first stack, of the stacks of the consumer products, on the base.

In at least one example embodiment, the guards are configured to be actuated from a first position to a second position, the first position causing the guards to grip the first stack, the second position causing the guards to be either separated or tilted away from the first stack.

In at least one example embodiment, the first wheel includes a base structure, the base structure being configured to rotate in the horizontal plane, an eccentric cam positioned in a central location above the base structure, the eccentric cam being affixed in a stationary position such that the eccentric cam does not rotate with the base structure, a piston operatively arranged within each one of the cutouts, each one of the pistons being connected to a rod that is supported by and rotated with the base structure, a bumper on a first end of each one of the rods, the bumper being configured to contact an interior surface of the eccentric cam, at least one first spring operatively connected to each one of the rods, a distal end of the at least one first spring being connected to the first end of a respective one of the rods, a proximal end of the at least one first spring being connected to a collar, the collar being between the eccentric cam and the first set of cutouts, the at least one first spring being configured to bias a respective one of the rods and pull the rods toward a respective one of the first set of cutouts.

In at least one example embodiment, an extended portion of the eccentric cam is closer to a first portion of the first set of cutouts relative to a remaining portion of the eccentric cam, the remaining portion of the eccentric cam having a circular shape from an overhead perspective.

In at least one example embodiment, the extended portion is configured to cause the at least one first spring to pull each one of the rods toward a respective one of the cutouts, of the first set of cutouts, such that the piston at least partially extends outward to discharge a respective one of the stacks from the first wheel at the extended portion of the cam.

In at least one example embodiment, the first wheel includes a base structure, the base structure being configured to rotate in the horizontal plane, an eccentric cam positioned in a central location above the base structure, the eccentric cam being affixed in a stationary position such that the eccentric cam does not rotate with the base structure, a piston operatively arranged within each one of the cutouts, each one of the pistons being connected to a rod that is supported by and rotated with the base structure, a bumper on a first end of each one of the rods, the bumper being configured to contact an interior surface of the eccentric cam, at least one first spring operatively connected to each one of the rods, a distal end of the at least one first spring being connected to the first end of a respective one of the rods, a proximal end of the at least one first spring being connected to a collar, the collar being between the eccentric cam and the first set of cutouts, the at least one first spring being configured to bias a respective one of the rods and pull the rods toward a respective one of the first set of cutouts.

In at least one example embodiment, an extended portion of the eccentric cam is closer to a first portion of the first set of cutouts relative to a remaining portion of the eccentric cam, the first portion being near the first unloading location, the remaining portion of the eccentric cam having a circular shape from an overhead perspective.

In at least one example embodiment, the extended portion is configured to cause the at least one first spring to pull each one of the rods toward a respective one of the cutouts, of the first set of cutouts, such that the piston at least partially extends outward to discharge a respective one of the stacks from the first wheel at the first unloading location.

In at least one example embodiment, the consumer products include a canister that is filled with a material prior to the consumer products being conveyed by the plurality of travel paths.

In at least one example embodiment, the material includes an oral product.

At least one example embodiment is directed toward a method.

In at least one example embodiment, the method includes first conveying a plurality of consumer products along a plurality of travel paths, the travel paths being in a side-by-side configuration, each one of the plurality of travel paths having a discharge point at a unique elevation; first rotating a first wheel in a first horizontal plane, the first wheel being near the discharge points of the plurality of travel paths, the first wheel defining a first set of cutouts around a periphery of the first wheel; and first discharging one first consumer product, of the plurality of consumer products, from each one of the plurality of travel paths into a respective one of the first set of cutouts, in a successive order as the first wheel rotates, to form stacks of the consumer products in each of the first set of cutouts.

In at least one example embodiment, the first conveying conveys via a chute that is at least partially defined by a feed tray for each one of the plurality of travel paths, each of the chutes being in the side-by-side configuration, a distal end of the chutes branching into the discharge points at the unique elevation.

In at least one example embodiment, the first conveying conveys such that each one of the chutes are further defined at least in part by a first structure on a first conveyor, the first structure being configured to transport the plurality of consumer products into the feed tray.

In at least one example embodiment, the first discharging discharges such that the first wheel accepts the one first consumer product from each one of the plurality of travel paths at a same time.

In at least one example embodiment, the first discharging discharges such that an elevation of each one of the discharge points incrementally increases, from a first discharge point of a first travel path to a last discharge point of a last travel path, of the plurality of travel paths, and the rotating rotates the first wheel in a direction that causes each of the first set of cutouts to pass in front of the discharge points in the successive order from the first discharge point to the last discharge point.

In at least one example embodiment, the method further includes second discharging the stacks of the consumer products from each one of the first set of cutouts once a first number of the consumer products in each of the stacks equals a second number of the plurality of travel paths.

In at least one example embodiment, the first number and the second number equal five.

In at least one example embodiment, the method further includes second discharging each one of the stacks of the consumer products from a respective one of the first set of cutouts of the first wheel into a respective holder, of a plurality of holders, at a first unloading location; and second conveying the plurality of holders in a first direction towards a second unloading location using a second conveyor, the second conveyor being adjacent to the first wheel.

In at least one example embodiment, the method further includes second discharging the stacks of consumer products from each one of the plurality of holders at the second unloading location.

In at least one example embodiment, the method further includes third conveying the plurality of holders from the second unloading location back to the first unloading location following the second discharging via the second conveyor, the third conveying including changing an orientation of each one of the plurality of holders from an upright orientation to at least one of a tilted orientation or an upside-down orientation at the second unloading location.

In at least one example embodiment, the method further includes third conveying the plurality of holders from the second unloading location back to the first unloading location following the second discharging via the second conveyor, the third conveying including transporting each one of the plurality of holders in an upside-down orientation during at least some of a travel distance as the second conveyor conveys the holders from the second unloading location back the first unloading location.

In at least one example embodiment, the second discharging discharges each one of the plurality of holders via a discharge device that at least partially discharges each of the stacks of the consumer products from each one of the holders at the second unloading location.

In at least one example embodiment, the method further includes second rotating a second wheel in the first horizontal plane, the second wheel being adjacent to the first wheel, the second wheel defining a second set of cutouts around a periphery of the second wheel; and second discharging each one of the stacks of the consumer products from the first set of cutouts to the second set of cutouts at a second unloading location.

In at least one example embodiment, the first rotating rotates the first wheel in a first rotational direction that is one of a clockwise or a counter-clockwise direction, and the second rotating rotates the second wheel rotates in a second rotational direction that is opposite the first rotational direction.

In at least one example embodiment, the first wheel has a first diameter and the second wheel has a second diameter, the first diameter being larger than the second diameter.

In at least one example embodiment, the first rotating rotates the first wheel at a first rotational speed and the second rotating rotates the second wheel at a second rotational speed, the first rotational speed being slower than the second rotational speed.

In at least one example embodiment, the method further includes second discharging each one of the stacks of the consumer products from a respective one of the second set of cutouts of the second wheel into a respective holder, of a plurality of holders, at a second unloading location; and second conveying the plurality of holders in a first direction towards a third unloading location using a second conveyor, the second conveyor being adjacent to the first wheel.

In at least one example embodiment, the method further includes third discharging the stacks of consumer products from each one of the plurality of holders at the third unloading location.

In at least one example embodiment, the method further includes third conveying the plurality of holders from the third unloading location back to the second unloading location following the third discharging via the second conveyor, the third conveying including transporting each one of the plurality of holders in an upside-down orientation during at least some of a travel distance as the second conveyor conveys the holders from the third unloading location back the second unloading location.

In at least one example embodiment, the method further includes heating the stacks via a heat tunnel as the second conveyor conveys the holders on the second conveyor, the heat tunnel at least partially covering the second conveyor.

In at least one example embodiment, the method further includes filling the plurality of consumer products with a material prior to the first conveying, each of the plurality of consumer products including a canister.

In at least one example embodiment, the material includes an oral product.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 is an illustration of a perspective view of a system, in accordance with at least one example embodiment;

FIG. 2 is an illustration of a top view of chutes of a system, in accordance with at least one example embodiment;

FIG. 3 is an illustration of a side view of chutes of a system, in accordance with at least one example embodiment;

FIG. 4A is an illustration of a rear view of chutes of a system, in accordance with at least one example embodiment;

FIG. 4B is an illustration of a front view of chutes of a system, in accordance with at least one example embodiment;

FIG. 4C is an illustration of a magnified view of an outlet of a chute shown in FIG. 4B, in accordance with at least one example embodiment;

FIG. 5 is an illustration of an upper perspective view a first conveyor and feed tray loading consumer products into a first wheel, in accordance with at least one example embodiment;

FIG. 6 is an illustration of another upper perspective view of a feed tray loading consumer products into a first wheel, in accordance with at least one example embodiment;

FIG. 7 is an illustration of a top view of a first wheel of a system (shown without a housing), in accordance with at least one example embodiment;

FIG. 8 is an illustration of an upper perspective view of a first wheel (shown without a housing) receiving consumer products from a feed loading tray and discharging stacks of the consumer products onto a second conveyor, in accordance with at least one example embodiment;

FIG. 9 is an illustration of a perspective view of a cam for a first wheel of a system, in accordance with at least one example embodiment;

FIG. 10A is an illustration of a cross-sectional view (view X-X of FIG. 7) of a first wheel of a system, in accordance with at least one example embodiment;

FIG. 10B is an illustration of a perspective view of rods and bumpers interacting with a cam of a first wheel (shown without a housing or a body of the wheel), in accordance with at least one example embodiment;

FIG. 10C is an illustration of a perspective view of rods and bumpers interacting with a cam of a first wheel (shown without a housing or a body of the wheel), in accordance with at least one example embodiment;

FIG. 11A is an illustration of a cross-sectional view (view XIA-XIA of FIG. 8) of a portion of a first wheel;

FIG. 11B is an illustration of a cross-sectional view (view XIB-XIB of FIG. 8) of a portion of the first wheel;

FIG. 12 is an illustration of a perspective view of a first wheel (shown without a housing), a loading tray of a first conveyor, and a second conveyor of a system, in accordance with at least one example embodiment;

FIG. 13A is an illustration of a perspective view of a second conveyor of a system, in accordance with at least one example embodiment;

FIG. 13B is an illustration of a holder of a second conveyor of the system, in accordance with at least one example embodiment;

FIG. 13C is an illustration of a holder holding a stack of the consumer products, in accordance with at least one example embodiment;

FIG. 13D is an illustration of a holder holding a stack of the consumer products with guards of the holder in an extended position, in accordance with at least one example embodiment;

FIG. 13E is an illustration of a holder holding a stack of the consumer products with guards of the holder in a retracted (normal) position, in accordance with at least one example embodiment;

FIG. 13F is an illustration of the holder holding a stack of the consumer products with a barrier material fitted around the stack, in accordance with at least one example embodiment;

FIG. 14 is an illustration of a user control arrangement for at least part of a system, in accordance with at least one example embodiment;

FIG. 15 is a method flowchart for using a system to form stacks of consumer products, in accordance with at least one example embodiment;

FIG. 16 is an illustration of a perspective view of a system, in accordance with at least one example embodiment;

FIG. 17 is an illustration of an overhead view of a system, in accordance with at least one example embodiment;

FIG. 18 is an illustration of a side view of a system, in accordance with at least one example embodiment;

FIG. 19 is an illustration of a lower perspective view of a system, in accordance with at least one example embodiment;

FIG. 20 is an illustration of another lower perspective view of a system, in accordance with at least one example embodiment;

FIG. 21 is an illustration of an upper perspective view of a system, in accordance with at least one example embodiment;

FIG. 22 is an illustration of a consumer product, in accordance with at least one example embodiment;

FIG. 23 is an illustration of a lower end of a consumer product, in accordance with at least one example embodiment; and

FIG. 24 is a flowchart depicting a method of stacking, in accordance with at least one example embodiment.

### DETAILED DESCRIPTION OF EXAMPLE EMBODIMENTS

Some detailed example embodiments are disclosed herein. However, specific structural and functional details disclosed herein are merely representative for purposes of describing example embodiments. Example embodiments may, however, be embodied in many alternate forms and should not be construed as limited to only the example embodiments set forth herein.

Accordingly, while example embodiments are capable of various modifications and alternative forms, example embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It should be understood that when an element or layer is referred to as being “on,” “connected to,” “coupled to,” “attached to,” “adjacent to,” or “covering” another element or layer, it may be directly on, connected to, coupled to, attached to, adjacent to or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, regions, layers and/or sections, these elements, regions, layers, and/or sections should not be limited by these terms. These terms are only used to distinguish one element, region, layer, or section from another region, layer, or section. Thus, a first element, region, layer, or section discussed below could be termed a second element, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing various example embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, and/or elements, but do not preclude the presence or addition of one or more other features, integers, steps, operations, elements and/or groups thereof.

When the words “about” and “substantially” are used in this specification in connection with a numerical value, it is intended that the associated numerical value include a tolerance of ±10% around the stated numerical value, unless otherwise explicitly defined. Moreover, when the terms “generally” or “substantially” are used in connection with geometric shapes, it is intended that precision of the geometric shape is not required but that latitude for the shape is within the scope of the disclosure. Furthermore, regardless of whether numerical values or shapes are modified as “about,” “generally,” or “substantially,” it will be understood that these values and shapes should be construed as including a manufacturing or operational tolerance (e.g., ±10%) around the stated numerical values or shapes.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of the example embodiments. However, it will be understood by one of ordinary skill in the art that example embodiments may be practiced without these specific details. For example, systems may be shown in block diagrams in order not to obscure the example embodiments in unnecessary detail. In other instances, well-known processes, structures and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “memory” may represent one or more devices for storing data, including random access memory (RAM), magnetic RAM, core memory, and/or other machine readable mediums for storing information. The term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, wireless channels, and various other mediums capable of storing, containing or carrying instruction(s) and/or data.

Furthermore, example embodiments may be implemented by hardware circuitry and/or software, firmware, middleware, microcode, hardware description languages, etc., in combination with hardware (e.g., software executed by hardware, etc.). When implemented in software, firmware, middleware or microcode, the program code or code segments to perform the desired tasks may be stored in a machine or computer readable medium such as a non-transitory computer storage medium, and loaded onto one or more processors to perform the desired tasks.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As used in this application, the term “circuitry” and/or “hardware circuitry” may refer to one or more or all of the following: (a) hardware-only circuit implementation (such as implementations in only analog and/or digital circuitry); (b) combinations of hardware circuits and software, such as (as applicable): (i) a combination of analog and/or digital hardware circuit(s) with software/firmware, and (ii) any portions of hardware processor(s) with software (including digital signal processor(s)), software, and memory(ies) that work together to cause an apparatus, such as a mobile phone, a smart device, and/or server, etc., to perform various functions); and (c) hardware circuit(s) and/or processor(s), such as microprocessor(s) or a portion of a microprocessor(s), that requires software (e.g., firmware) for operation, but the software may not be present when it is not needed for operation. For example, the circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

At least one example embodiment refers to methods performing image searches using an online platform. While the various example embodiments of the present disclosure are discussed in connection with the an online platform for the sake of clarity and convenience, the example embodiments are not limited thereto, and one of ordinary skill in the art would recognize the example embodiments may be applicable to other online and/or mobile services, such as a website, a web portal, a social networking service (SNS), a forum, an instant messaging service, a chat service, a search engine, an e-commerce platform, etc.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

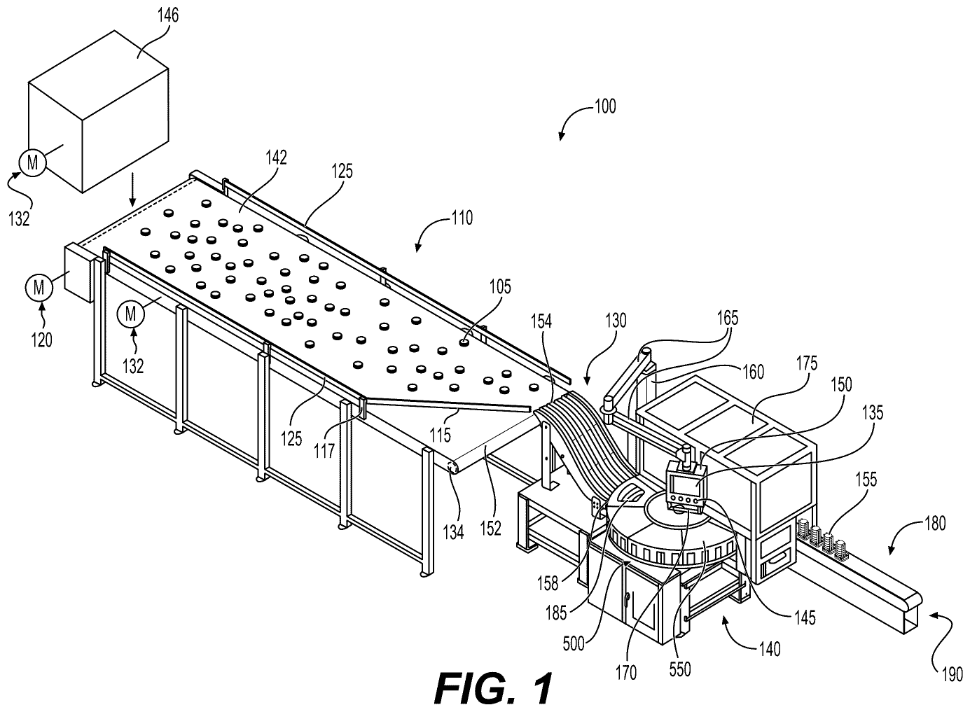

FIG. 1 is an illustration of a perspective view of a system 100, in accordance with at least one example embodiment.

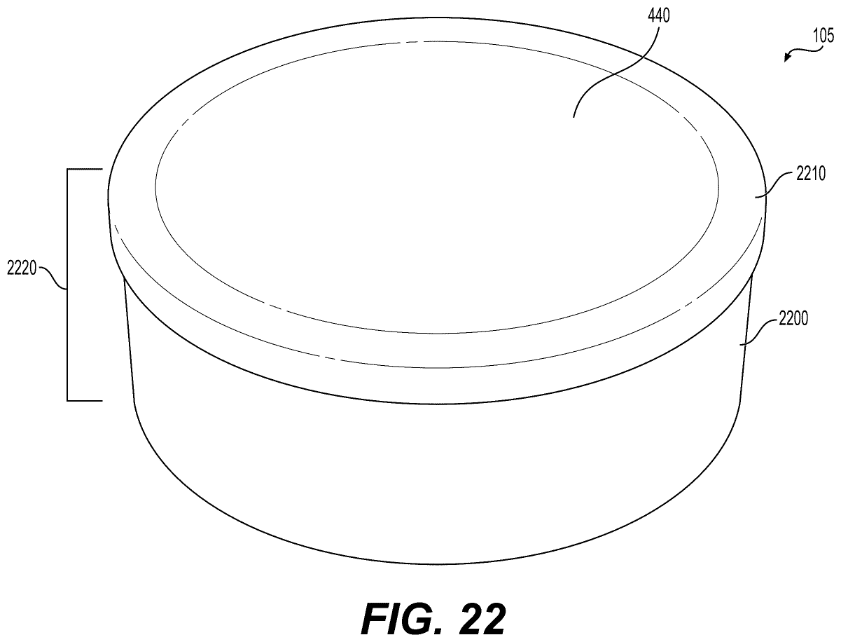

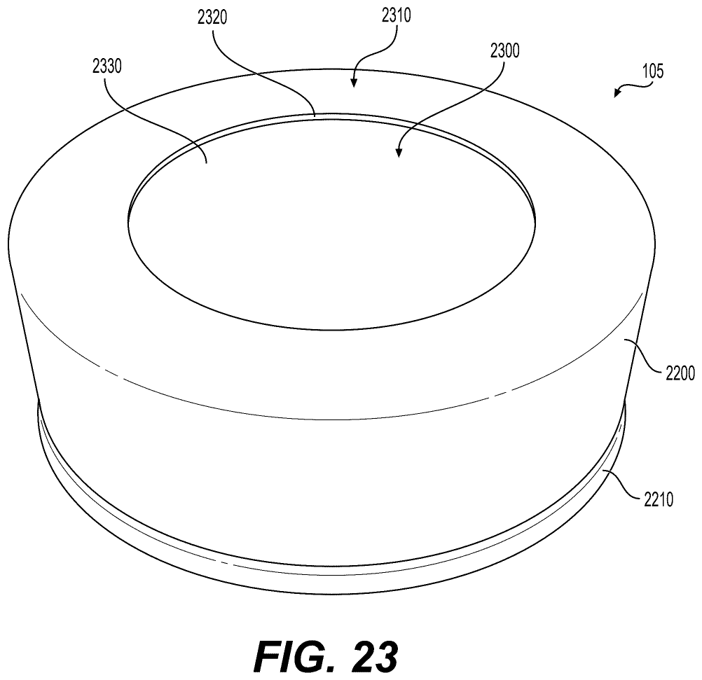

In at least one example embodiment, the system 100 is configured to form stacks 155 of consumer products 105. In at least one example embodiment, the stacking of the consumer products 105 is used for a storage, shipment, dispensing and/or sale of the consumer products 105. In at least one example embodiment, and as shown in FIGS. 22 and 23, the consumer products 105 may include for instance a canister (can).

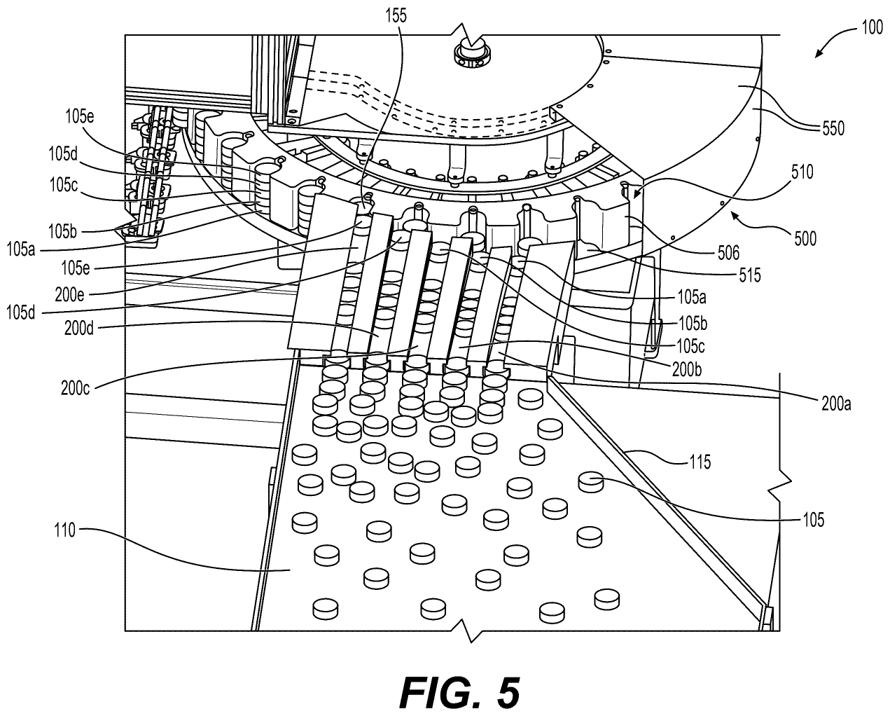

In at least one example embodiment, major components of the system 100 include a first conveyor 110, a feed tray 130, a stacking section 140, and a second conveyor 180. In at least one example embodiment, a number of the consumer products 105 move across the first conveyor 110 and travel through the feed tray 130 where the consumer products 105 are discharged at different elevations onto a wheel 500 (a “first wheel”; see at least FIGS. 5, 7 and 8) within the stacking section 140 to form the stacks 155. In at least one example embodiment, the stacks 155 are transferred onto the second conveyor 180 to be unloaded at a first unloading location (first discharge location) 190. In at least one example embodiment, the system 100 includes a heat tunnel 175 to help shrink wrap and/or further process the stacks 155, as described herein in more detail.

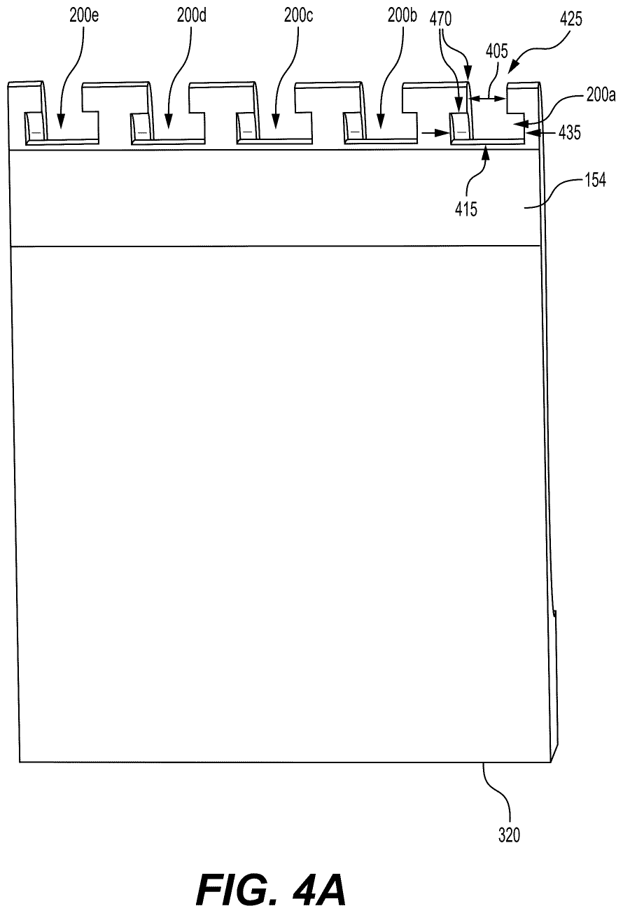

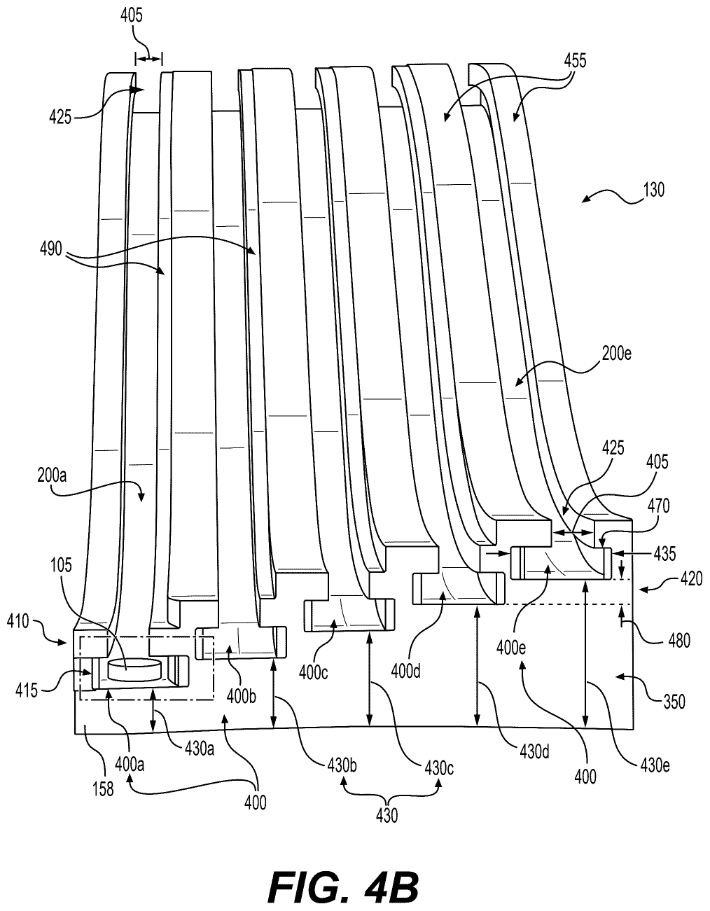

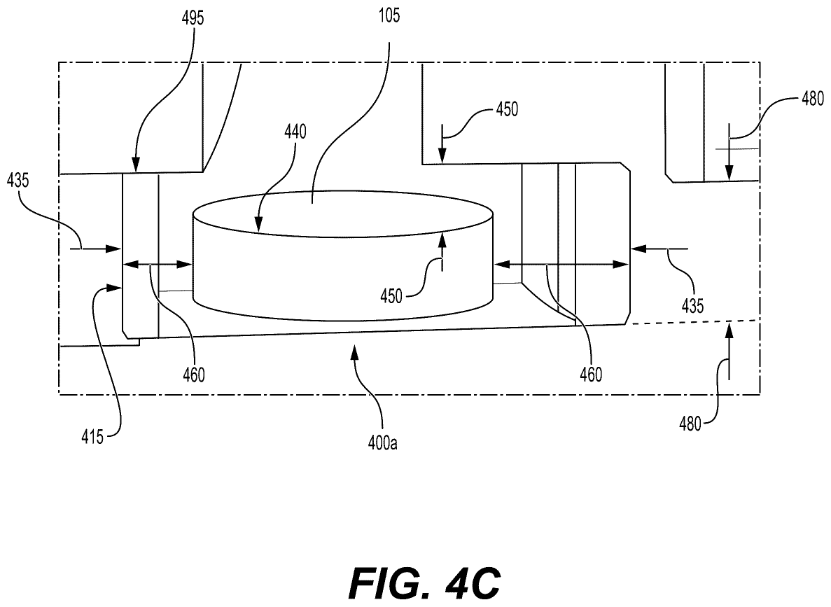

In at least one example embodiment, the consumer products 105 are containers, canisters or cans. In at least one example embodiment, the consumer products 105 are canisters or cans that are cylindrical in shape (see FIGS. 22 and 23). In at least one example embodiment, the consumer products 105 can be a container that is a non-cylindrical shape, such as a container with a square shape or a square profile (e.g., square shaped from an overhead view or square shaped from a side view), a container with a rectangular, triangular, or a polygonal profile (e.g., from an overhead view or a side view), etc., or a container of another shape. In at least one example embodiment, the consumer product 105 has opposing flat surfaces that allow the container to be stackable (see the instant example embodiment in at least FIGS. 4C, 22 and 23).

In at least one example embodiment, the consumer products 105 are canisters containing an oral product. In at least one example embodiment, the oral product is a tobacco product or a non-tobacco product. The oral product may include chewing tobacco, snus, moist snuff tobacco, dry snuff tobacco, or other smokeless tobacco products and non-tobacco products for oral consumption. The smokeless tobacco products may include tobacco that is whole, shredded, cut, granulated, reconstituted, cured, aged, fermented, pasteurized, or otherwise processed. The tobacco may be present as portions of leaves, flowers, roots, stems, extracts, or any combination thereof. In at least one example embodiment, the oral product includes a tobacco extract, such as a tobacco-derived nicotine extract (e.g., white snus), alone or in combination with non-tobacco cellulosic materials (e.g., microcrystalline cellulose (MCC). In at least one example embodiment, the oral product includes nicotine, with or without tobacco, and the nicotine may be tobacco-derived nicotine or synthetic nicotine. In at least one example embodiment, the oral product may be provided loose, in a pouch, as a plug or twist, or in a desired shape. In at least one example embodiment, the oral product may be in the form of lozenges, chews, gums, pouches, sticks, tablets, pastilles, or any other suitable form.

In some example embodiments, the tobacco product includes a tobacco material that may be from any member of the genus Nicotiana. In addition, the tobacco material may include a blend of two or more different tobacco varieties. Examples of suitable types of tobacco materials that may be used include, but are not limited to, flue-cured tobacco, Burley tobacco, Dark tobacco, Maryland tobacco, Oriental tobacco, rare tobacco, specialty tobacco, blends thereof, and the like. The tobacco material may be provided in any suitable form, including, but not limited to, tobacco lamina, processed tobacco materials, such as volume expanded or puffed tobacco, processed tobacco stems, such as cut-rolled or cut-puffed stems, reconstituted tobacco materials, blends thereof, and the like. In some example embodiments, the tobacco material is in the form of a substantially dry tobacco mass. Furthermore, in some instances, the tobacco material may be mixed and/or combined with at least one of propylene glycol, glycerin, sub-combinations thereof, or combinations thereof.

In at least one example embodiment, oral product may further include one or more elements such as a mouth-stable polymer, a mouth-soluble polymer, a sweetener (e.g., a synthetic sweetener and/or a natural sweetener), an energizing agent, (e.g., theanine and/or melatonin), a focusing agent (e.g., Ginkgo biloba), a plasticizer, mouth-soluble or partially-soluble fibers (e.g., sugar beet fibers), an alkaloid, a mineral, a vitamin, a dietary supplement, a nutraceutical, a coloring agent, an amino acid, a chemesthetic agent, an antioxidant, a food-grade emulsifier, a pH modifier, a botanical (e.g., green tea), a tooth-whitening agent (e.g., sodium hexametaphosphate (SHMP)), a therapeutic agent, a processing aid, a stearate (e.g., magnesium and/or potassium), a wax (e.g., glycerol monostearate, propylene glycol monostearate, and/or an acetylated monoglyceride), a stabilizer (e.g., ascorbic acid and monosterol citrate, butylated hydroxytoluene (BHT), or butylated hydroxyanisole (BHA)), a lubricant (e.g., sodium lauryl sulfate (SLS)), a disintegrating agent, a lubricant, a preservative (e.g., sodium benzoate), a filler, a flavorant, an effervescent (e.g., carbon dioxide embedded in a flavorant or a filling material), flavor masking agents, a bitterness receptor site blocker, a receptor site enhancers, other additives, or any combination thereof. The oral product may include multiple additional elements. Additionally, a single element may belong to more than one of the categories above.

As used herein, the term “nutraceuticals” refers to any ingredient in foods that has a beneficial effect on human health. Nutraceuticals include particular compounds and/or compositions isolated from natural food sources and genetically modified food sources. Suitable nutraceuticals include, without limitation, various phytonutrients derived from natural plants and genetically engineered plants. The nutraceuticals can be included in an amount of about 0.1% to about 5% by weight based on the weight of the composition for human consumption.

In at least one example embodiment, the oral product may include the energizing agent. In at one example embodiment, the energizing agent includes caffeine, taurine, glucaronalactone, guarana, vitamin B6, vitamin B12, or any combination thereof.

Caffeine, also known as 1,3,7-trimethylxanthine, is a white, odorless, bitter tasting substance. Caffeine occurs naturally in tea, coffee, and chocolate, and is commonly added to soft drinks, energy drinks and some foods. However, because of the bitter taste of caffeine, the flavor of drinks or foods having a relatively high caffeine content can be unappealing. Caffeine may include synthetic caffeine and/or natural caffeine, such as coffee bean-extracted caffeine. In at least one example embodiment, the oral product includes caffeine in an amount greater than or equal to about 10 mg (e.g., greater than or equal to about 25 mg, greater than greater than or equal to about 150 mg) The caffeine may be included in an amount less than or equal to about 200 mg (e.g., less than or equal to about 150 mg, less than or equal to about 100 mg, less than or equal to about 75 mg, less than or equal to about 50 mg, or less than or equal to about 25 mg).

The compositions for human consumption have a relatively high caffeine content so as to provide a consumer with a burst of energy. Moreover, the compositions for human consumption contain about 50 mg to about 200 mg of caffeine or about 75 mg to about 175 mg of caffeine (e.g., 100 mg to about 150 mg of caffeine) so as to provide a burst of energy to the consumer. The composition provides a single serving of a food, drink, oral tobacco product or oral non-tobacco product. A single serving of food can have a weight of about 5 g to about 450 g. A single serving of drink is about 200 mL to about 600 mL. A single serving of an oral pouch product includes one oral pouch product formed as described herein.

Optionally, the composition for human consumption can also include additional energizing ingredients in addition to the caffeine complex. Suitable energizing ingredients include, without limitation, taurine, citicoline, and guarana. The energizing ingredients can be included in an amount of about 0.1% to about 5% by weight based on the weight of the composition for human consumption.

In at least one example embodiment, the soothing agent includes theanine, melatonin, or both theanine and melatonin. The soothing agent may also include, for example only, chamomile, lavender, jasmine, soursop, cannabidiol, or any combination thereof. The soothing agent can be added as a flavorant and or aroma embedded in the product and/or the package. The soothing agents can be included in an amount of about 0.1% to about 5% by weight based on the weight of the composition for human consumption.

In at least one example embodiment, the focusing agent includes Ginkgo biloba.

The at least one sensate or chemesthesis agent may include mint, menthol, cinnamon, pepper, jambu, or any combination thereof. The at least one sensate or chemesthesis agent may include any soothing, cooling, and/or warming agent. For example, in some example embodiments, the at least one sensate or chemesthesis agent may include capsaicin, pipeline, alpha-hydroxy-sanshool, and (8)-gingerole, which may be selected so as to provide a warm, tingling or burning sensation. In other example embodiments, the at least one sensate or chemesthesis agent may include menthol, menthyl lactate, WS-3 (N-Ethyl-p menthane-3-carboxamide), WS-23 (2-Isopropyl-N,2,3-trimethylbutyramide) and Evercool 180™ (available from Givaudan SA), which may be selected so as to provide a cooling sensation. The at least one sensate or chemesthesis agent may be included in an amount ranging from about 0.01% by weight to about 5% by weight based on the weight of the oral pouch product.

The antioxidant may include, for example, vitamin C, vitamin B, magnesium, calcium, or any combination thereof.

Suitable minerals include, without limitation, calcium, magnesium, phosphorus, iron, zinc, iodine, selenium, potassium, copper, manganese, molybdenum, chromium, and mixtures thereof. The amount of minerals incorporated into the composition for human consumption can be varied according to the type of mineral and the intended adult consumer. For example, the amount of minerals may be formulated to include an amount less than or equal to the recommendations of the United States Department of Agriculture Recommended Daily Allowances.

Amino acids can also be included in the composition for human consumption. Suitable amino acids include, without limitation, the eight essential amino acids that cannot be biosynthetically produced in humans, including valine, leucine, isoleucine, lysine, threonine, tryptophan, methionine, and phenylalanine. Examples of suitable amino acids include the non-essential amino acids including alanine, arginine, asparagine, aspartic acid, cysteine, glutamic acid, glutamine, glycine, histidine, proline, serine, and tyrosine. The amino acids can be included in an amount of about 0.1% to about 5% by weight based on the weight of the composition for human consumption.

In at least one example embodiment, the at least one functional ingredient may be included in an amount ranging from about 0.01% by weight to about 5% by weight based on the weight of the oral pouch product (e.g., about 0.1 wt. % to about 4.5 wt. %, about 1 wt. % to about 4 wt. %, about 1.5 wt. % to about 3.5 wt. %, about 2 wt. % to about 3 wt. %).

In at least one example embodiment, the oral product is an oral tobacco product, an oral non-tobacco product, an oral cannabis product, or any combination thereof. The oral product may be in a form of loose material (e.g., loose cellulosic material), shaped material (e.g., plugs or twists), pouched material, tablets, lozenges, chews, gums, films, any other oral product, or any combination thereof.

The oral product may include chewing tobacco, snus, moist snuff tobacco, dry snuff tobacco, other smokeless tobacco and non-tobacco products for oral consumption, or any combination thereof.

Where the oral product is an oral tobacco product including a smokeless tobacco product, the smokeless tobacco product may include tobacco that is whole, shredded, cut, granulated, reconstituted, cured, aged, fermented, pasteurized, or otherwise processed. Tobacco may be present as whole or portions of leaves, flowers, roots, stems, extracts (e.g., nicotine), or any combination thereof.

In at least one example embodiment, the oral product includes a tobacco extract, such as a tobacco-derived nicotine extract, and/or synthetic nicotine. The oral product may include nicotine alone or in combination with a carrier (e.g., white snus), such as a cellulosic material. The carrier may be a non-tobacco material (e.g., microcrystalline cellulose) or a tobacco material (e.g., tobacco fibers having reduced or eliminated nicotine content, which may be referred to as “exhausted tobacco plant tissue or fibers”). In some example embodiments, the exhausted tobacco plant tissue or fibers can be treated to remove at least 25%, 40%, 50%, 60%, 70%, 75%, 80%, 85%, 90%, or 95% of the nicotine. For example, the tobacco plant tissue can be washed with water or another solvent to remove the nicotine.

In other example embodiments, the oral product may include cannabis, such as cannabis plant tissue and/or cannabis extracts. In at least one example embodiment, the cannabis material includes leaf and/or flower material from one or more species of cannabis plants and/or extracts from the one or more species of cannabis plants. The one or more species of cannabis plants may include Cannabis sativa, Cannabis indica, and/or Cannabis ruderalis. In at least one example embodiment, the cannabis may be in the form of fibers. In at least one example embodiment, the cannabis may include a cannabinoid, a terpene, and/or a flavonoid. In at least one example embodiment, the cannabis material may be a cannabis-derived cannabis material, such as a cannabis-derived cannabinoid, a cannabis-derived terpene, and/or a cannabis-derived flavonoid.

The oral product (e.g., the oral tobacco product, the oral non-tobacco product, or the oral cannabis product) may have various ranges of moisture. In at least one example embodiment, the oral product is a dry oral product having a moisture content ranging from 5% by weight to 10% by weight. In at least one example embodiment, the oral product has a medium moisture content, such as a moisture content ranging from 20% by weight to 35% by weight. In at least one example embodiment, the oral product is a wet oral product having a moisture content ranging from 40% by weight to 55% by weight.

In at least one example embodiment, the tobacco product may include smokeless tobacco pouches. In at least one example embodiment, the non-tobacco product may include herbal compositions, pharmaceutical medications, or other non-tobacco products. Herbs and other edible plants can be categorized generally as culinary herbs (e.g., thyme, lavender, rosemary, coriander, dill, mint, peppermint) and medicinal herbs (e.g., Dahlias, Cinchona, Foxglove, Meadowsweet, Echinacea, Elderberry, Willow bark). In some example embodiments, the non-tobacco products may include cannabis or cannabis extracts.

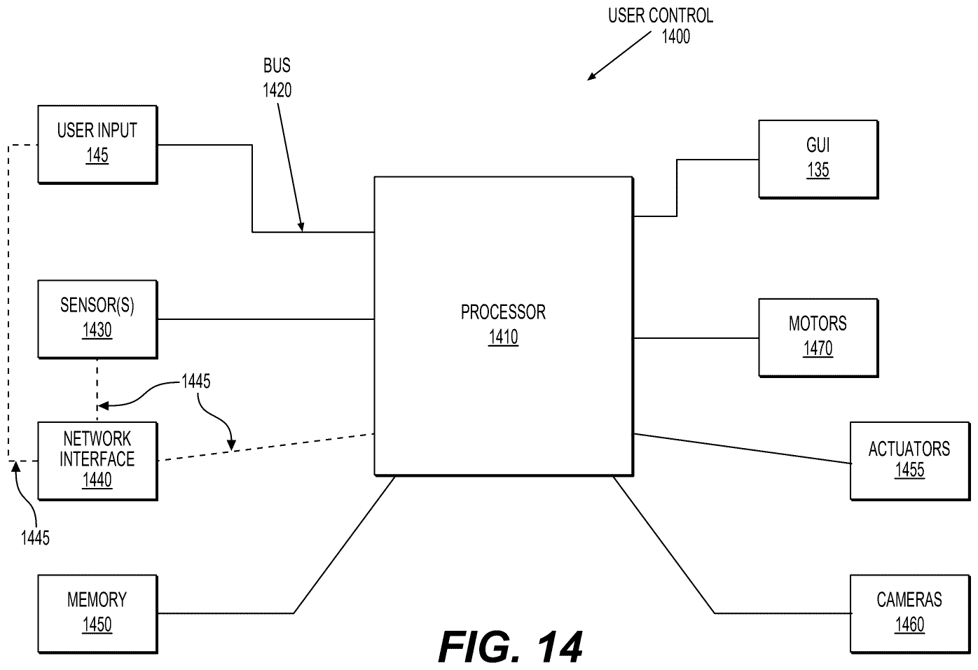

In at least one example embodiment, the consumer products 105 are stored in a container 146 that is on an end of the first conveyor 110, or the consumer products 105 are placed or dropped into the container 146, prior to the consumer products 105 being distributed from the container 146 onto the first conveyor 110. In at least one example embodiment, one or more motors 132 are connected to the container 146 to shake and/or vibrate the consumer products 105 in the container 146 to cause the consumer products 105 to drop onto the first conveyor 110 (where a further discussion of the operation of the one or more motors 132 is included in relation to FIG. 14). In at least one example embodiment, the one or more motors 132 includes, or is, a vibratory motor. In at least one example embodiment, the consumer products 105 are transferred from the container 146 onto the first conveyor 110 by hand, via the use of a robot or a robotic arm, via pneumatic or hydraulic devices, where gravity and/or bursts of directed air may assist or cause the transfer of the consumer products 105 onto the first conveyor 110.

In at least one example embodiment, the first conveyor 110 is an accumulation table that conveys a large number of the consumer products 105 toward a desired location at a first end 154 of the feed tray 130. In at least one example embodiment, the first conveyor 110 includes a belt 142 that travels on one or more rollers 134, where rotation of the rollers 134 causes movement of the belt 142 that transports the consumer products 105 towards a downstream end 152 of the first conveyor 110. In at least one example embodiment, the belt 142 is driven by a motor 120 (as described in further detail in relation to FIG. 14). In at least one example embodiment, the first conveyor 110 includes rails 125 on lateral sides of the first conveyor 110 to keep the consumer products 105 on the first conveyor 110. In at least one example embodiment, a portion 115 of the railing 125 may be selectively angled to direct the consumer products 105 toward the feed tray 130, where the feed tray 130 may vary in size and/or width. In at least one example embodiment, the portion 115 of the railing 125 can pivot on a hinge 117 to re-direct the consumer products 105 in a desired direction.

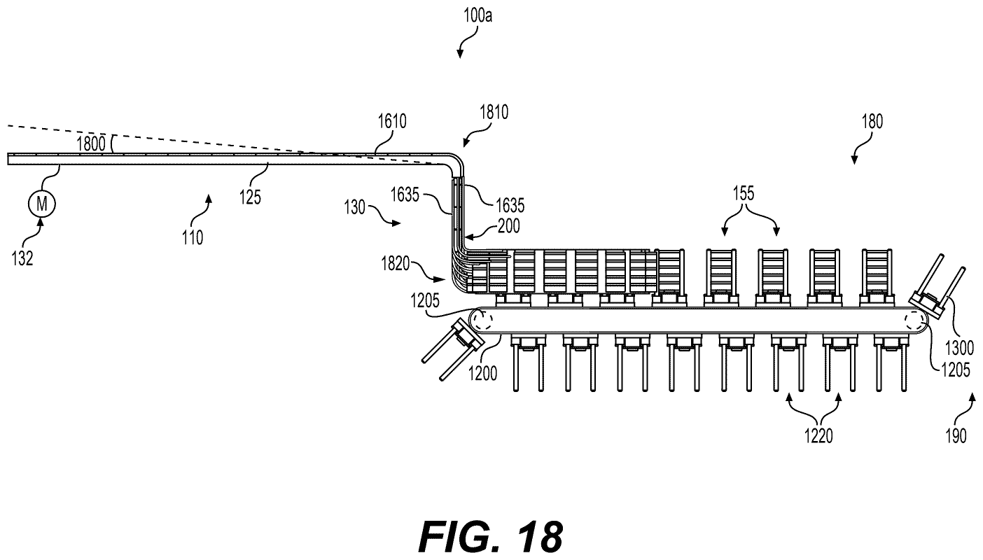

In at least one example embodiment, the one or more motors 132 are connected to the first conveyor 110 to shake and/or vibrate the first conveyor 110 to assist the consumer products 105 in traveling along the first conveyor 110. In at least one example embodiment, the first conveyor 110 includes the belt 142 without the one or more motors 132, or the first conveyor 110 includes the one or more motors 132 without the belt 142. In at least one example embodiment, other mechanical, pneumatic, hydraulic, magnetic, robotic and/or electronic devices or structure are used to convey the consumer products 105 along the first conveyor 110. In at least one example embodiment, the consumer products 105 are conveyed into the feed tray 130 by gravity, by hand, via a robot or robotic arm, or other known means of conveying the consumer products 105 to the feed tray 130. In at least one example embodiment, the first conveyor 110 is sloped (see FIG. 18 and the associated description), thereby allowing gravity to at least partially assist movement of the consumer products 105 along the first conveyor 110. In at least one example embodiment, the system 100 does not include the first conveyor 110 and instead the consumer products 105 are transferred directly into the feed tray 130, or the consumer products 105 are distributed from the container 146 directly into the feed tray 130, by any of the means described herein, or by any combination of the means described herein. Other devices or structure of conveying the consumer products 105 into the feed tray 130 are contemplated.

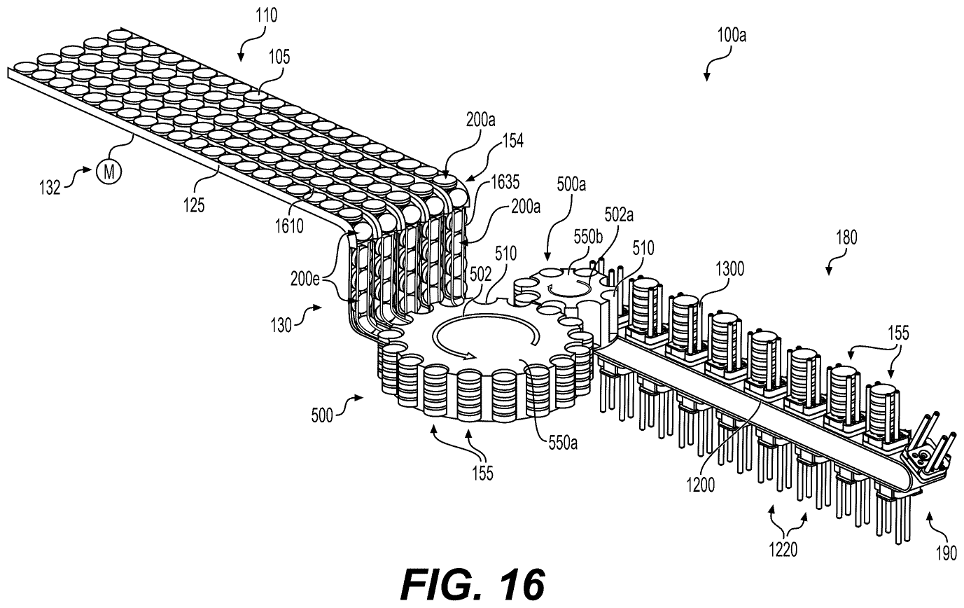

In at least one example embodiment, the downstream end 152 of the first conveyor 110 aligns with the first end 154 of the feed tray 130. In at least one example embodiment, a second end 158 of the feed tray 130 aligns with a portion of the stacking section 140 to individually load the consumer products 105 into the stacking section 140. In at least one example embodiment, a relative size, an arrangement and/or a position of the major elements of the system 100 (e.g., the first conveyor 110, the feed tray 130, the stacking section 140 and the second conveyor 180) can be different than the configuration shown in FIG. 1. In at least one example embodiment, the system 100 could include a second wheel (such as a second wheel 500a of a system 100a, shown in FIG. 16).

In at least one example embodiment, the system 100 includes a user control device 150 that is used to control elements of the system 100. In at least one example embodiment, the user control device 150 is a stationary device or a device with limited movement that is accessed within direct proximity to the system 100. In at least one example embodiment, the user control device 150 is a mobile device that includes one or more of a personal computer (PC), tablet, cellphone, other hand-held devices, or combinations thereof. Other forms of the user control device 150 are contemplated. In at least one example embodiment, the user control device 150 includes a graphical user interface (GUI) 135 and user inputs 145 for respectively viewing and inputting information to monitor and control the system 100 or elements of the system 100. In at least one example embodiment, the GUI 135 includes a screen, such as a light-emitting diode (LED) screen, or any other suitable screen, that displays information to a user. In at least one example embodiment, the GUI 135 includes touchscreen capabilities that works in conjunction with the user inputs 145, or in lieu of the user inputs 145, to view information and act as an input/output (I/O) device. In at least one example embodiment, the user inputs 145 include buttons, knobs, switches, dials, a separate touch screen or screens, a keyboard, a mouse, a microphone and/or speaker, voice-activated controls, a camera, or combinations thereof, that allow the user control device 150 to be an I/O device. Other capabilities and configurations of the user control device 150 are contemplated. Further functions of the user control device 150, and a detailed discussion of elements of the system 100 that the user control device 150 controls, is included in relation to FIG. 14.

In at least one example embodiment, the user control device 150 is suspended on a post 160, where one or more arms 165 allow the user control device 150 to be pivoted and/or moved into convenient locations for better viewing while the system 100 is being controlled. In at least one example embodiment, a handle 170 is on a front of the user control device 150 to assist in moving the user control device 150. In at least one example embodiment, a housing 550 of the wheel 500 includes an aperture (window) 185 that allows for visual confirmation that the stacks 155 of the consumer products 105 are being properly loaded onto the wheel 500, as discussed in more detail herein. In at least one example embodiment, the aperture 185 is used to visually confirm and/or prevent jamming of the consumer products 105, where the aperture 185 is larger enough to allow the consumer products and/or the stacks 155 to be removed from the wheel 500.

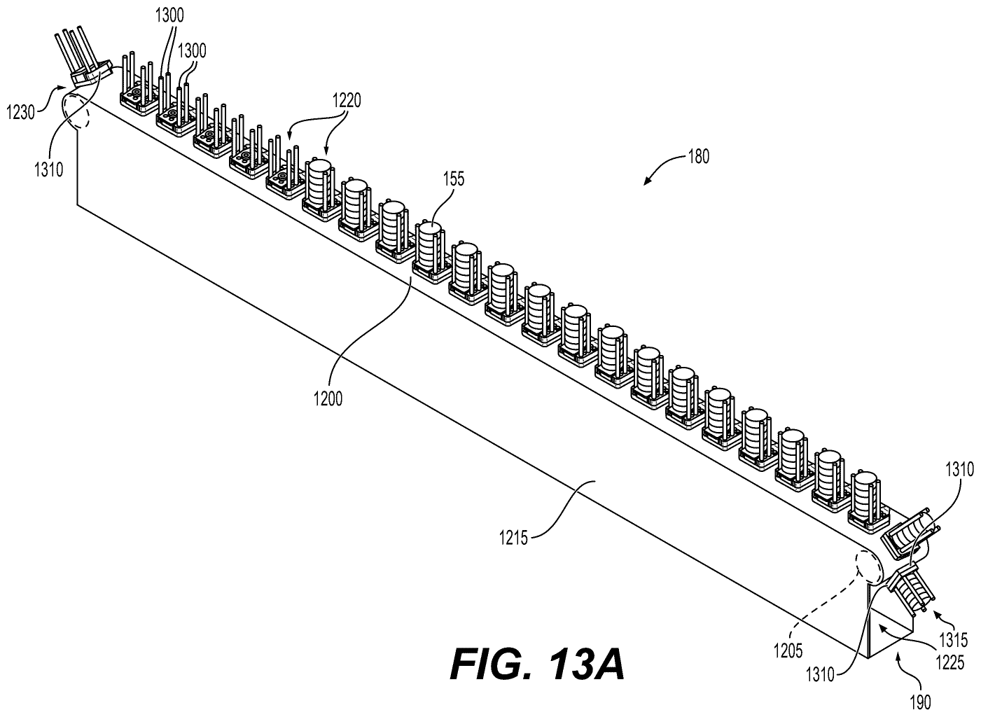

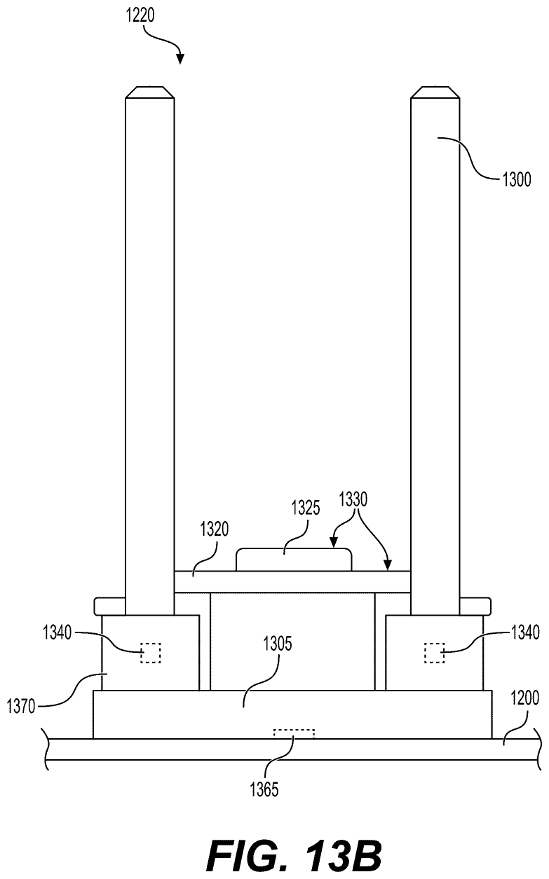

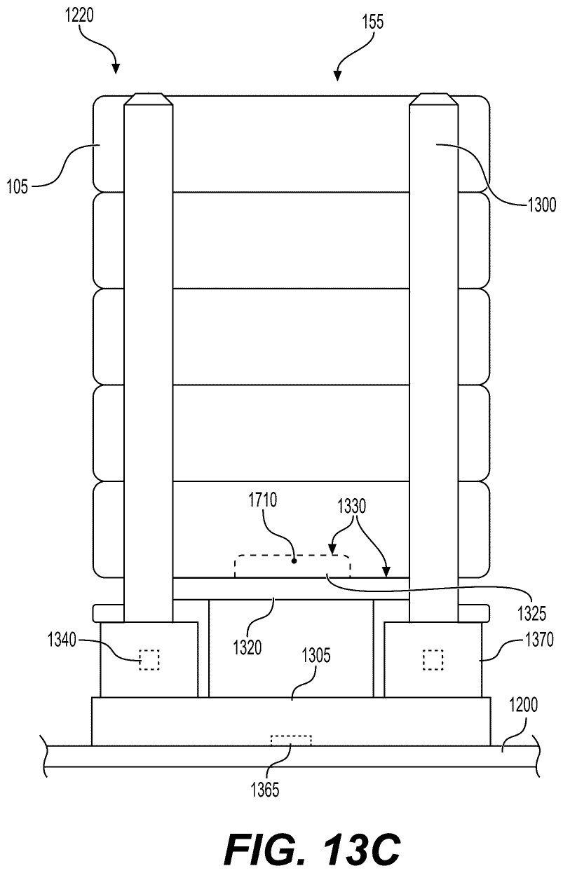

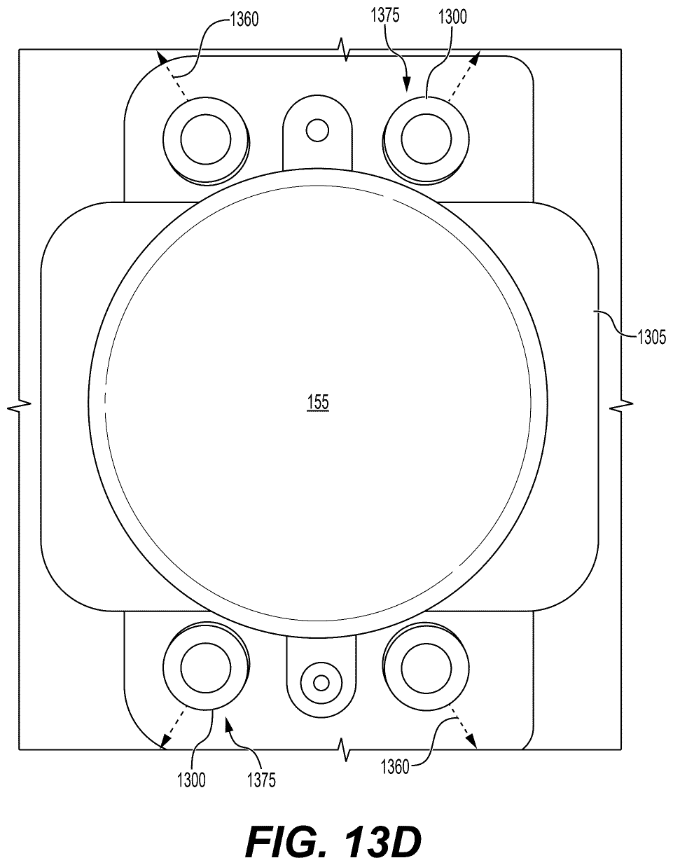

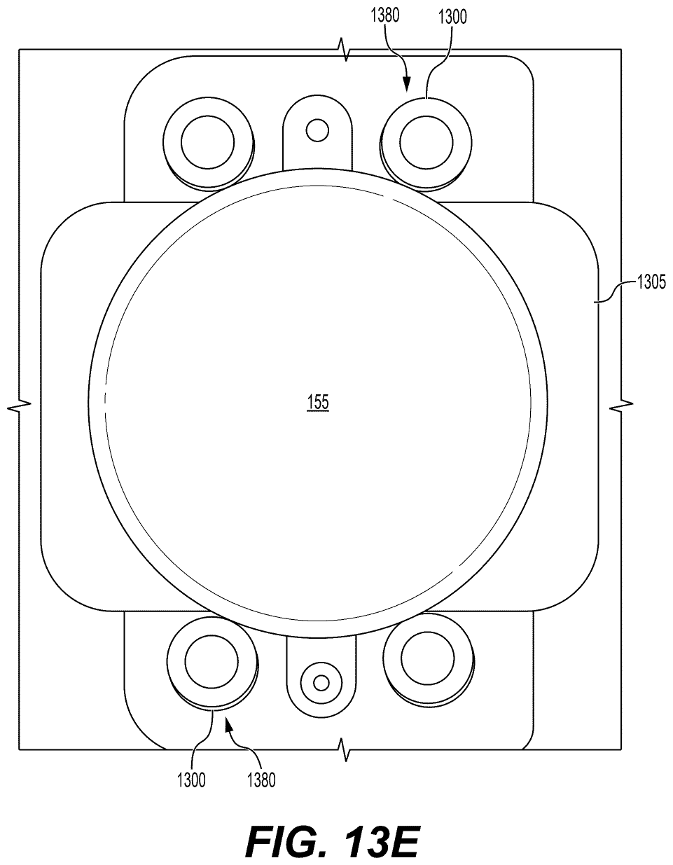

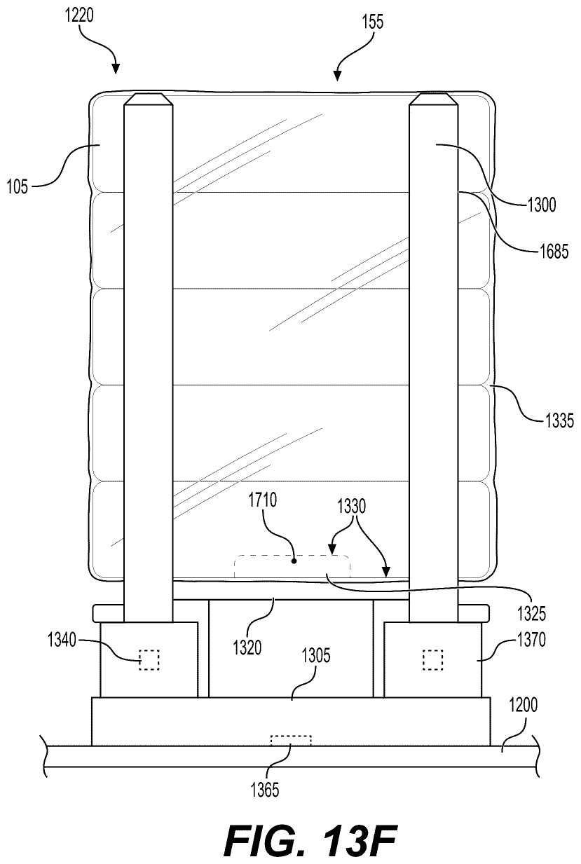

In at least one example embodiment, the heat tunnel 175 envelopes, circumscribes and/or at least partially covers at least a portion of the second conveyor 180. In at least one example embodiment, the heat tunnel 175 exposes the stacks 155 to heat while the stacks are on the second conveyor 180. In at least one example embodiment, the heat tunnel 175 heats the stacks 155 after a barrier material 1335 has been applied to the stacks 155, for the purpose of heating and activating the barrier material 1335 to at least partially adhere the barrier material 1335 onto the stacks 155 (see FIG. 13E for a further discussion).

In at least one example embodiment, the heat tunnel 175 is configured to heat the stacks 155 at any location within the system that is “downstream” from the wheel 500, such that the heat tunnel 175 heats the stacks 155 at any point after being discharged from the wheel 500. In at least one example embodiment, the heat tunnel 175 is located at the first unloading location 190. In at least one example embodiment, the heat tunnel 175 is “downstream” of the second conveyor 180, such that the heat tunnel 175 heats the stacks 155 after the stacks 155 have been unloaded from the second conveyor 180. In at least one example embodiment, the system 100 includes a third conveyor at the first unloading location 190 (not shown), and the heat tunnel 175 heats the stacks 155 on the third conveyor. Other configurations of the heat tunnel 175, and other devices or modes of heating the stacks 155 are contemplated.

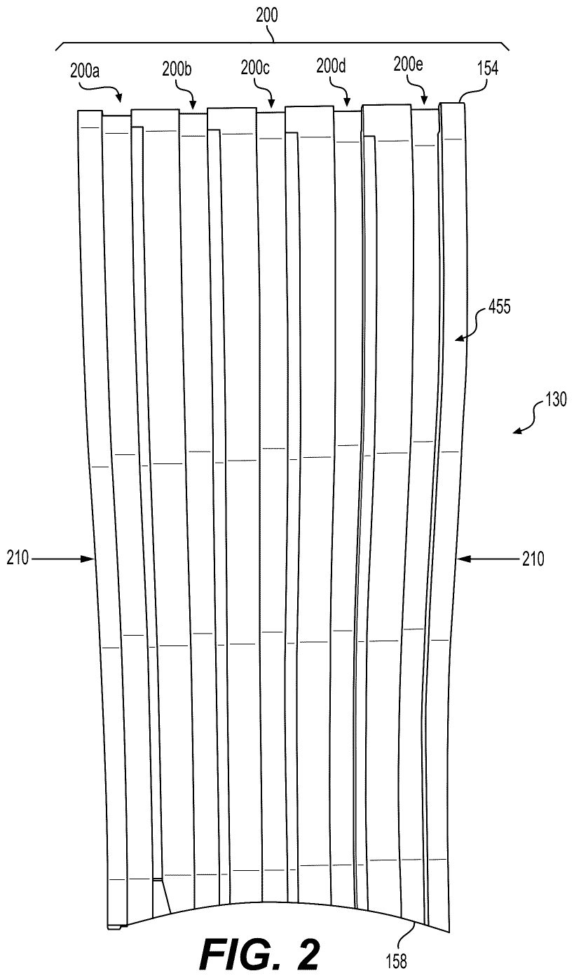

FIGS. 2, 3, 4A-C are top, side, back, front and magnified views of the feed tray 130 of the system 100, in accordance with at least one example embodiment.

In at least one example embodiment, the feed tray 130 include chutes (grooves, channels, ruts, lanes or “travel paths”) 200 extending longitudinally along, across, or through the feed tray 130. In at least one example embodiment, the chutes 200 are equally spaced apart across a width 210 of the feed tray 130. In at least one example embodiment, the feed tray 130 includes a range of between two and ten of the chutes 200. In at least one example embodiment, the feed tray 130 includes five of the chutes 200, as shown in FIGS. 2-4B. In at least one example embodiment, a number of the chutes 200 equals a number of the consumer products 105 that are included in each of the stacks 155 of the consumer products 105, as explained herein in more detail.

In at least one example embodiment, each of the chutes 200 includes a vertical cross-sectional flow area 470 with an enlarged portion 415 that is embedded within a main structure 350 of the feed tray 130 (see FIGS. 4A and 4B). In at least one example embodiment, the enlarged portion 415 is conformed to a general size of a side profile of the consumer product 105 (see at least FIGS. 4B and 4C showing a single one of the consumer products 105 being discharged from a first chute 200a). In at least one example embodiment, the vertical cross-sectional flow area 470 of each chute 200 includes a narrowed portion 425 that is a groove or a channel that is above the enlarged portion 415 (see at least FIGS. 4A and 4B), where the narrowed portion 425 includes a width 405 that is narrow relative to a width 435 of than the enlarged portion 415. In at least one example embodiment, the narrowed portion 425 allows the enlarged portion 415 to be at least partially accessed or viewed at least from above the feed tray 130. In at least one example embodiment, the narrowed portion 425 allows for a visual confirmation of a proper flow of the consumer products 105 through each of the chutes 200 of the feed tray 130. In at least one example embodiment, the narrowed portion 425 is small enough to ensure the consumer products 105 remain in the enlarged portion 415 even during a high-speed mass transport of the consumer products 105 through the feed tray 130. In at least one example embodiment, the narrowed portion 425 is wide enough to allow the chutes 200 to be manually cleared, or cleared by a robotic arm or other mechanical and/or pneumatic means (e.g., a piston, a jet of air pressure, etc.), in the event any one of the chutes 200 becomes jammed during an operation of the system 100.

In at least one example embodiment, a grate, a grill, a covering (translucent, transparent and/or opaque) covers a top of the narrowed portion 425 (not shown), where the grate, the grill or the covering may be removed from the feed tray 130 to access the chutes 200, or alternatively the grate, the grill or the covering may be selectively and individually removable from one or more of the chutes 200 while covering a remainder of the chutes 200. In at least one example embodiment, the chutes 200 may be embedded below an upper surface 455 of the feed tray 130 such that the narrowed portion 425 does not exist. In this example embodiment, at least a portion of the upper surface 455 may be removable from the feed tray 130 (not shown) to address jamming of the feed tray 130 during operation of the system 100.

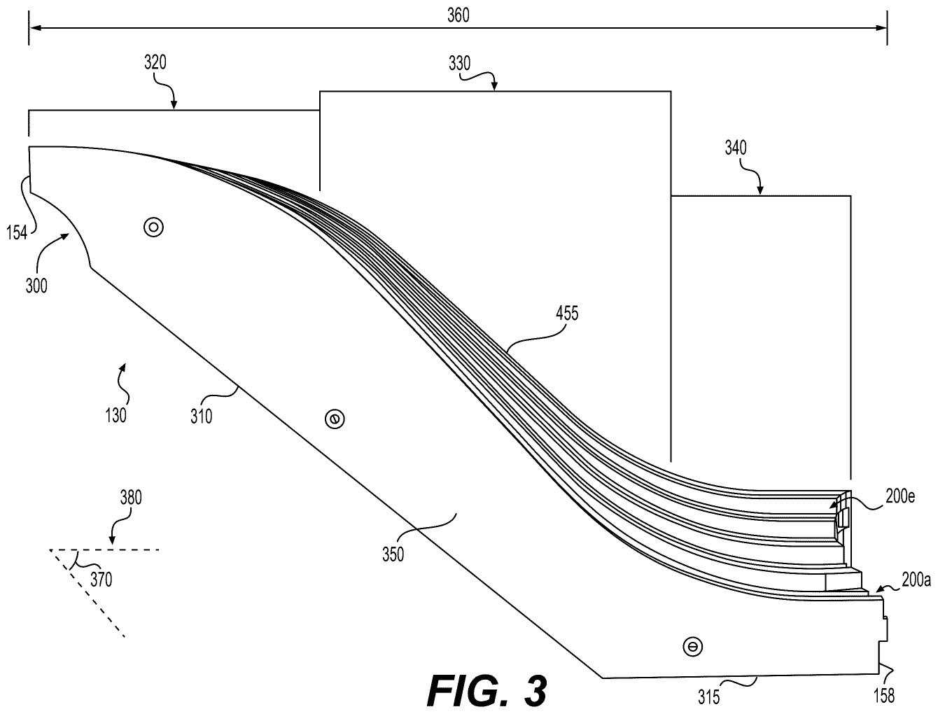

In at least one example embodiment, the vertical cross-sectional flow area 470 of each of the chutes 200 is uniform, from the first end 154 to the second end 158 of the feed tray 130. In at least one example embodiment, the chutes 200 are defined across a longitudinal length 360 of the feed tray 130 (FIG. 3), or along an upper surface 455 of the feed tray 130 along the longitudinal length 360 (see at least FIGS. 2, 3 and 4B). In at least one example embodiment, the chutes 200 are troughs that are defined by the upper surface 455.

In at least one example embodiment, and as shown in FIGS. 4B and 4C, each of the chutes 200 is sized to be somewhat larger than a side profile of the consumer product 105 (see the consumer product 105 exiting a first outlet 400a of the first chute 200a in FIG. 4B, and a magnified view of the outlet 400a in FIG. 4C). In at least one example embodiment, and as shown in FIG. 4C, a clearance height 450 between an upper surface 440 of the consumer product 105 and a top 495 of the outlet 400a is about 2-10 mm, or about 3-8 mm, or about 4 mm. In at least one example embodiment, a combined clearance width 460 between the sides of the consumer product 105 and sides of the chute 200 (total width on both sides of the consumer product 105) is about 2-10 mm, or about 3-8 mm, or about 4 mm.

In at least one example embodiment, in the event the consumer products 105 are a shape other than a cylindrical shape, the consumer products 105 may need to be oriented properly, prior to entering the feed tray 130. In at least one example embodiment, at the downstream end 152 of the first conveyor 110 and/or at the first end 154 of the feed tray 130, a filter, a device, a robotic arm or other structure (not shown) may be used to properly orient the consumer product 105. In at least one example embodiment, a “proper orientation” of the consumer product 105 can include ensuring that the consumer product 105 is sitting on a flat surface of the consumer product 105. In at least one example embodiment, a “proper orientation” of the consumer product 105 can include ensuring that a profile of the consumer product 105 is aligned with the enlarged portion 415 of the chutes 200 at an entrance of the feed tray 130 (see FIG. 4A). In at least one example embodiment, a “proper orientation” of the consumer product 105 can include ensuring that a first flat surface (such as a lower surface 2310 of the consumer product 105 as shown in FIG. 23) is oriented to be in a downward position, where an opposing second flat surface of the consumer product 105 (such as the upper surface 440 of the consumer product 105 shown in FIG. 22) is oriented to be in an upward position, in order to ensure that a profile of the consumer product 105 can properly fit through the entrance of the chutes 200 and ensure that the consumer products 105 are in a proper orientation for stacking on the wheel 500.

In at least one example embodiment, and as shown in FIG. 4B, each of the chutes 200 has an outlet (discharge point) 400 that is at an elevation (vertical height) 430 that is unique (different). In at least one example embodiment, there is a staggered increase in the elevation 430 of each of the chutes 200, between consecutive outlets 400 (from the first outlet 400a to a fifth outlet 400e), from a first side 410 to a second side 420 of the feed tray 130. In at least one example embodiment, an elevation increase 480 between each of the outlets 400 is the same between each successive one of the chutes 200, where the elevation increase 480 is associated with the height 2220 of the consumer products 105 (see FIG. 22). Specifically, in at least one example embodiment, the elevation increase 480 between the outlets 400 (from a first elevation 430a of the first outlet 400a to a fifth elevation 430e of the fifth outlet 400e), is equal to the height 2220 of the consumer product 105.

In at least one example embodiment, the first elevation 430a of the first outlet 400a of the first chute 200a is slightly above a bottom surface 515 of a cutout 510 of the wheel 500 (see FIG. 5) to ensure that the consumer products 105 exiting the first chute 200a can be adequately loaded onto the wheel 500. In at least one example embodiment, a difference in elevation between the first elevation 430a (FIG. 4B) and an elevation of the bottom surface 515 is about 1-4 mm, or about 2 mm. In at least one example embodiment, a step 490 is defined by the upper surface 455 of the feed tray 130 (as shown in at least FIG. 4B), next to the narrowed portion 425 of each of the chutes 200, where the step 490 accounts for the elevation increase 480 between each successive one of the outlets 400. In at least one example embodiment, the step 490 effectively reduces an overall amount of material to form the main structure 350 of the feed tray 130.

In at least one example embodiment, the feed tray 130 (shown in at least FIGS. 2-4B) loads each of the consumer products 105 individually onto the wheel 500 (shown in at least FIGS. 5-8). In at least one example embodiment, the wheel 500 rotates in a horizontal plane (e.g., a plane that is perpendicular to gravity).

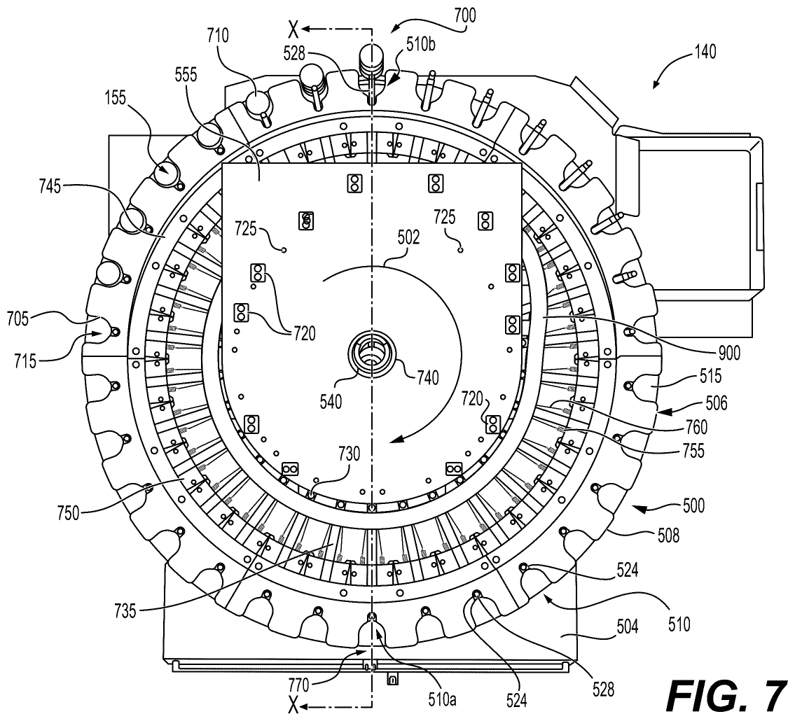

In at least one example embodiment, the wheel 500 has a rotational direction 502 that is clockwise (see FIG. 7), such that the elevation increase 480 between each successive one of the outlets 400 of the feed tray 130 increases, from the first side 410 to the second side 420 of the feed tray 130 (as shown in FIG. 4B). In at least one example embodiment, the rotational direction 502 of the wheel 500 is counter-clockwise (opposite of what is shown in FIG. 7), such that the elevation increase 480 between each successive one of the outlets 400 would necessarily be reversed, such that the fifth elevation 430e of the fifth outlet 400e would be a lowest elevation of the feed tray 130, and each successive one of the outlets 400 would increase by the elevation increase 480, from the second side 420 to the first side 410 of the feed tray 130 (opposite of what is shown in FIG. 4B).

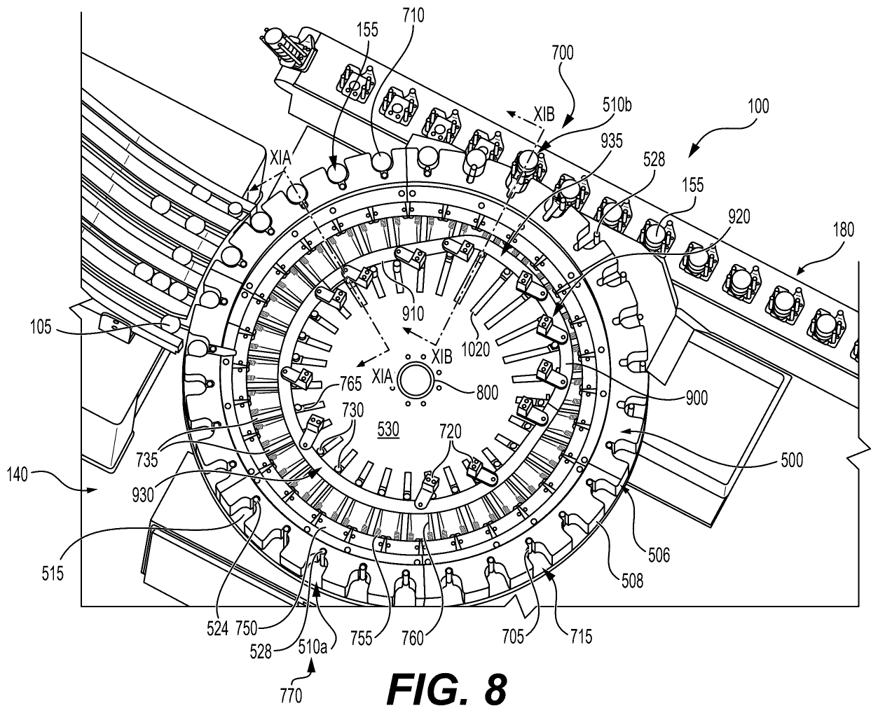

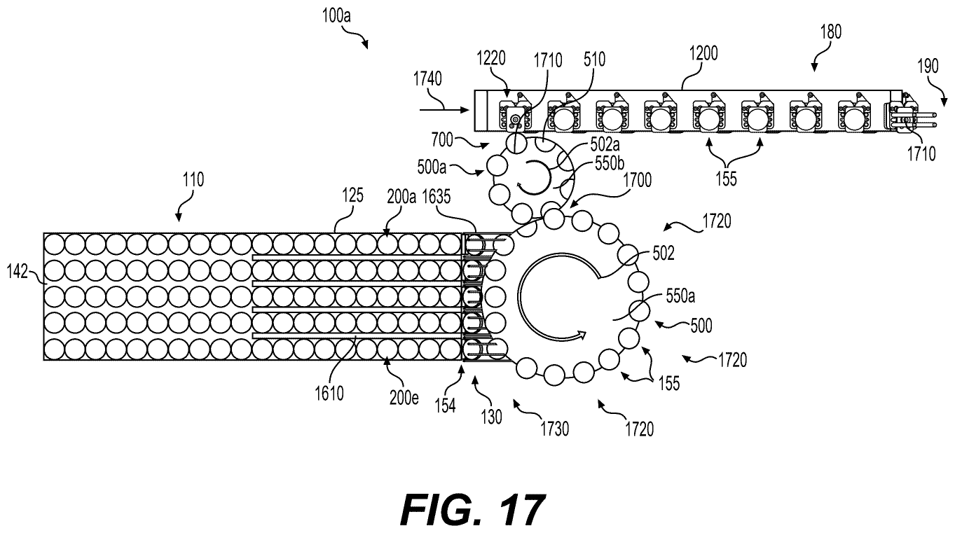

In at least one example embodiment, the second end 158 of the feed tray 130 has a concave shape that is conformed to match a general shape of the wheel 500 (see FIGS. 2 and 8 in particular; also see an embodiment of a feed tray 1630 in FIG. 17). In at least one example embodiment, the concave shape of the second end 158 allows the consumer products 105 to be loaded from each of the outlets 400 (FIG. 4B) onto the wheel 500 at a same time (simultaneously) onto a different (successive) one of the cutouts 510 of the wheel 500 (as depicted in at least FIG. 5).

In at least one example embodiment, and as shown in at least FIG. 3, the main structure 350 of the feed tray 130 has a bottom surface 315 that is relatively flat, and an angled lower surface 310 that extends the first end 154 of the feed tray 130 towards the downstream end 152 of the first conveyor 110 (as shown in FIG. 1). In at least one example embodiment, the feed tray 130 has a hook 300 that can least partially hook the first end 154 of the feed tray 130 to the downstream end 152 of the first conveyor 110 and/or another portion of the first conveyor 110. In at least one example embodiment, and as shown in FIG. 3, the upper surface 455 of the feed tray 130 includes a first portion 320, a second portion 330 and a third portion 340—where the first portion 320 and the third portion 340 provide the chutes 200 with a relatively gradual incline, and the second portion 330 provides the chutes 200 with a relatively steeper incline. In at least one example embodiment, the gradual incline of the first portion 320 and the third portion 340 allow the consumer products 105 to more easily enter and exit the chutes 200 during an exchange of the consumer products 105 onto the first conveyor 110 and onto the wheel 500, whereas the steeper inline of the second portion 330 gives the consumer products 105 momentum to be expediently and fully discharged from the feed tray 130 onto the wheel 500. In at least one example embodiment, the relatively steep incline of the second portion 330 allows a production speed of the system 100 to be increased, as this incline causes the consumer products 105 to move more rapidly through the feed tray 130. In at least one example embodiment, an incline angle 370 (relative to “horizontal” 380) of the first portion 320 and the third portion 340 is in a range of about 5-20 degrees, or about 10-15 degrees. In at least one example embodiment, the incline angle 370 (relative to “horizontal” 380) of the second portion 330 is in a range of about 15-75 degrees, or about 25-65 degrees, or about 35-55 degrees, or about 45 degrees.

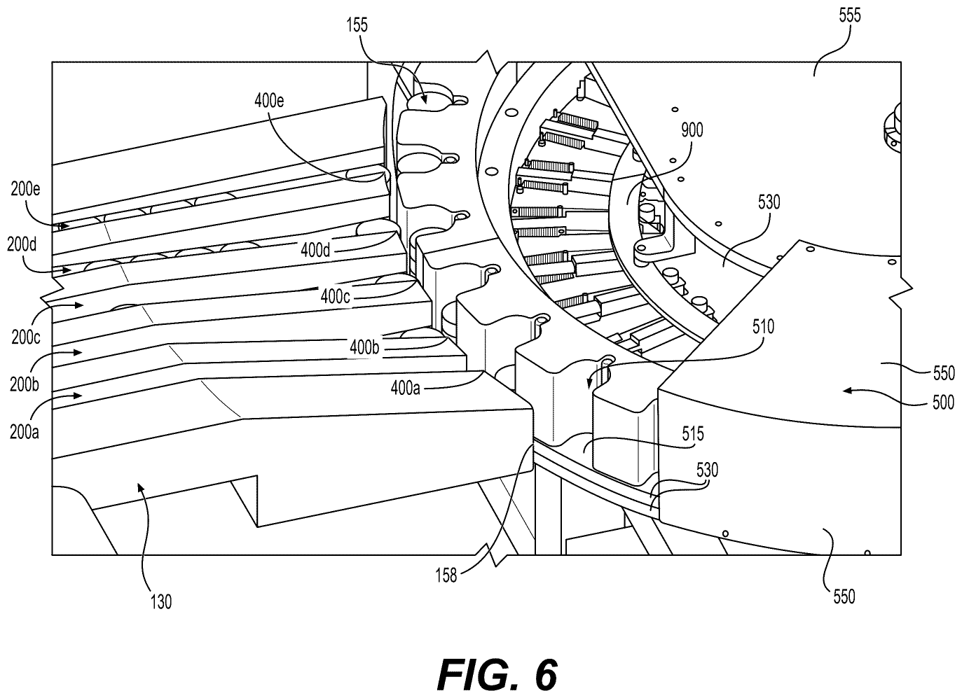

FIG. 5 is an illustration of an upper perspective view the first conveyor 110 and feed tray 130 loading the consumer products 105 into the wheel 500, in accordance with at least one example embodiment. FIG. 6 is an illustration of a perspective view of the feed tray 130 loading the consumer products 105 into the wheel 500, in accordance with at least one example embodiment.

In at least one example embodiment, and as shown in FIGS. 5 and 6, the wheel 500 includes the housing 550 that at least partially encloses and protects internal elements of the wheel 500 (see FIGS. 7 and 8 where internals of the wheel 500 are depicted without the housing 550). In at least one example embodiment, the wheel 500 rotates such that the cutouts (“first set of cutouts”) 510 consecutively align with each one of the chutes 200, as the cutouts 510 pass by the feed tray 130. In at least one example embodiment, each of the chutes 200 discharges one of the consumer products 105 at a same time (simultaneously) into a separate one of the cutouts 510. In at least one example embodiment, each one of the cutouts 510 passes in front of the outlets 400 of the chutes 200 (FIG. 4B), where the cutout 510 collects a single one of the consumer products 105 from each one chute 200 to form the stack 155 within the cutout 510, such that a first consumer product 105a from the first chute 200a is on a bottom of the stack and a fifth consumer product 105e is on a top of the stack 155, and the consumer products 105 from a second chute 200b, a third chute 200c and a fourth chute 200d are consecutively stacked in order in a middle of the stack 155 (see at least FIG. 5).

In at least one example embodiment, the wheel 500 rotates at a speed that facilitates a successful transfer of the consumer products 105 between the feed tray 130 and the cutouts 510. In at least one example embodiment, a slower movement of the wheel 500 allows a better opportunity for an inspection, removal and/or adjustment of the consumer products 105 and/or stacks 155 on the wheel 500, though a slower movement of the wheel 500 reduces a production capacity of the system 100.

In at least one example embodiment, each of the consumer products 105 are loaded into the cutout 510 by a gravitational force acting on the consumer product 105, by an inertial force of the other consumer products 105 in the chutes 200 acting on (pushing on) the consumer product 105, or combinations thereof. In at least one example embodiment, a transfer of the consumer products 105 from the feed tray 130 onto the wheel 500 is at least partially further assisted by mechanical, pneumatic and/or hydraulic means that may a robot or robotic arm, bursts of directed air, or combinations thereof.

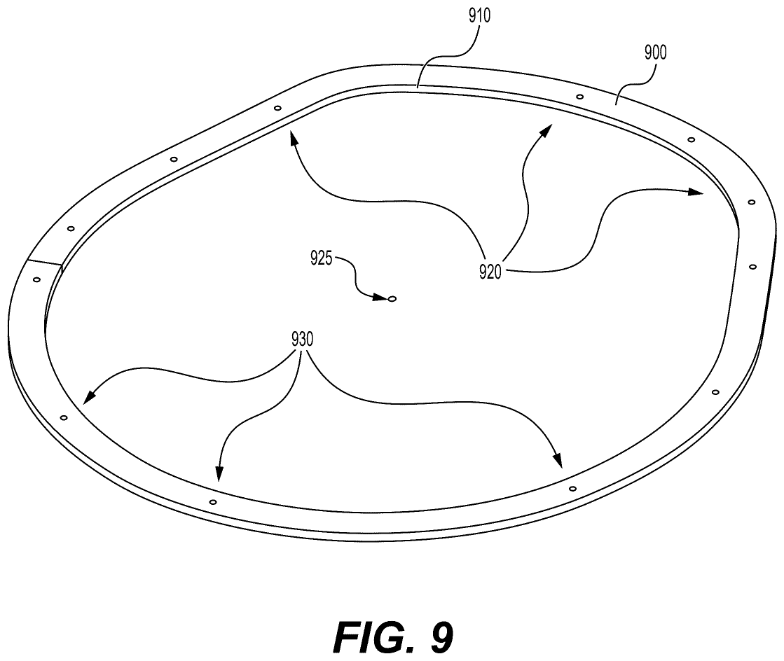

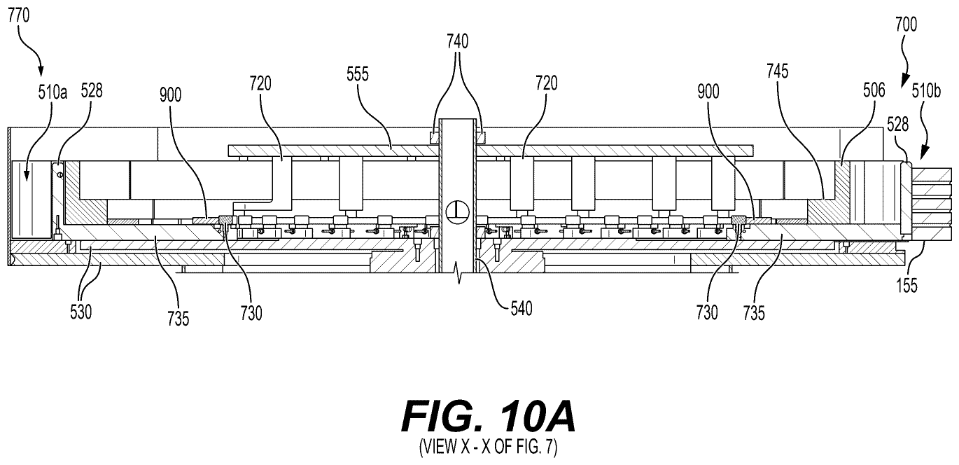

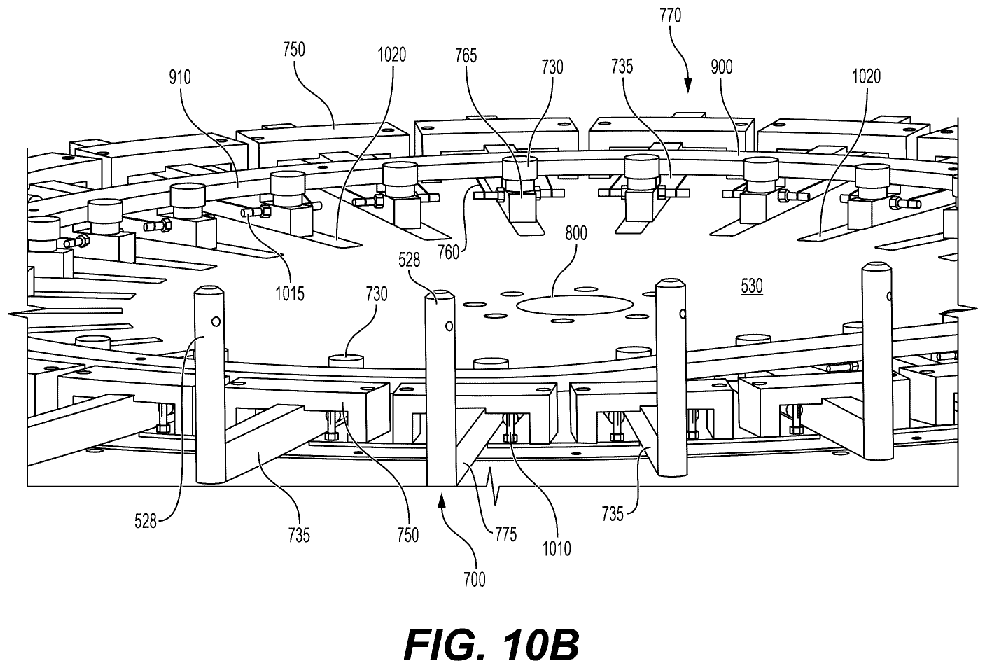

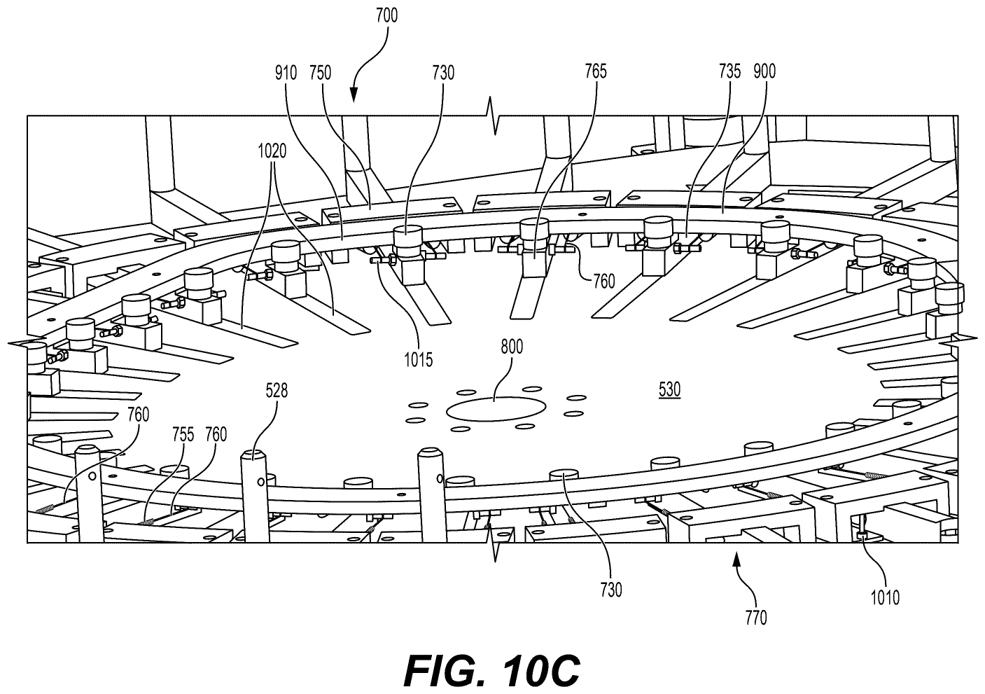

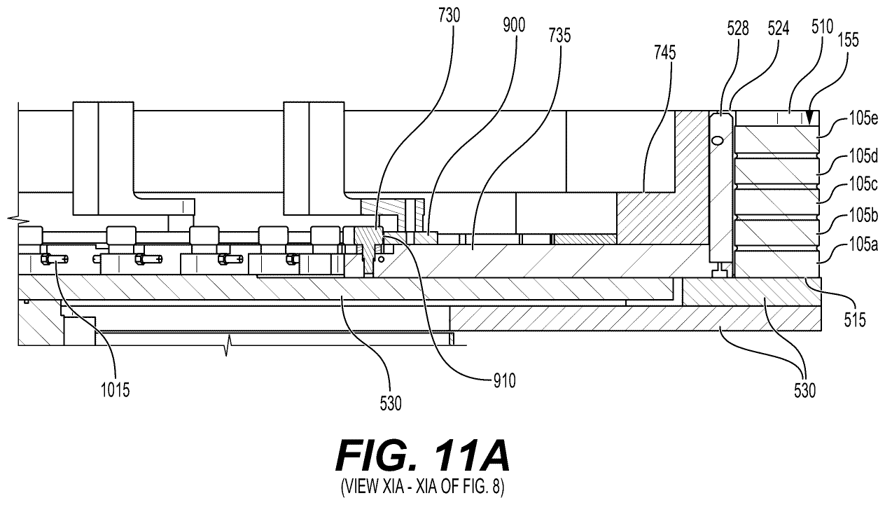

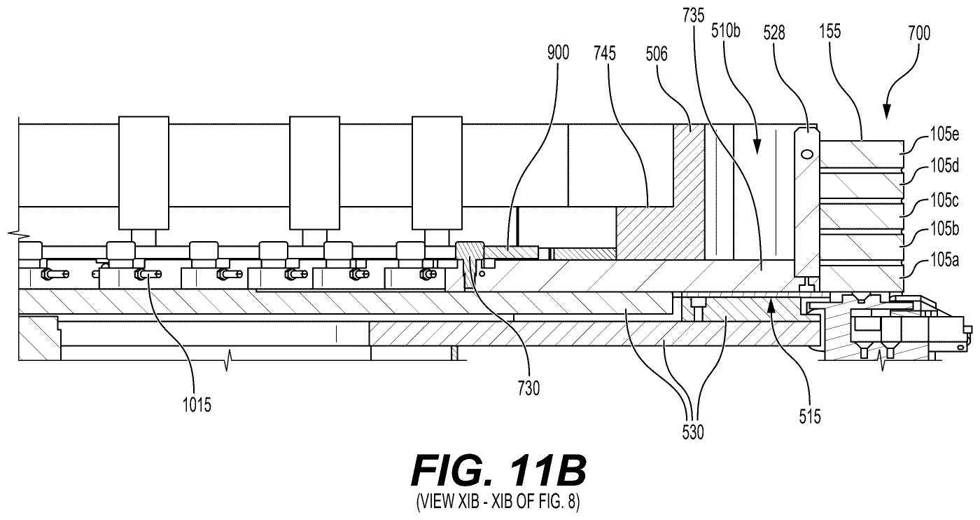

FIGS. 7 and 8 are upper views of internals of the wheel 500 (shown without the housing 550), in accordance with at least one example embodiment. FIG. 9 is an illustration of a perspective view of a cam 900 for the wheel 500 of the system 100, in accordance with at least one example embodiment. FIG. 10A is an illustration of a cross-sectional view (view X-X of FIG. 7) of the wheel 500, in accordance with at least one example embodiment. FIGS. 10B and 10C is an illustration of a perspective view of internals of the wheel 500, in accordance with at least one example embodiment. FIG. 11A is an illustration of a cross-sectional view (view XIA-XIA of FIG. 8) of a portion of the wheel 500, in accordance with at least one example embodiment. FIG. 11B is an illustration of a cross-sectional view (view XIB-XIB of FIG. 8) of a portion of the wheel 500, in accordance with at least one example embodiment.

Referring to FIGS. 7 and 8, in at least one example embodiment, the wheel 500 that is rotatably connected to a base structure 530. In at least one example embodiment, the body 506 is a donut-shaped structure that defines the cutouts (pockets) 510 along an outer periphery of the body 506. In at least one example embodiment, the cutouts 510 are equally spaced apart around an outer circumferential wall 508 of the body 506. In at least one example embodiment, a number of the cutouts 510 of the wheel 500 is between about 20-50, or between about 25-40, or about 40.

In at least one example embodiment, the body 506 defines the cutouts 510 to be an “impression” (imprint) of at least a portion of the stack 155 of the consumer products 105. In at least one example embodiment, each one of the cutouts 510 has a horizontal cross-section 715 that is U-shaped (shown in at least FIGS. 7 and 8). In at least one example embodiment, a back portion 705 of the horizontal cross-section 715 of the cutouts 510 is conformed to match an impression of a portion of a footprint (horizontal cross-section) 710 of the stacks 155 of the consumer products 105. In at least one example embodiment, each one of the cutouts 510 has a depth and height that is able to receive and securely hold each of the stacks 155 (see at least FIGS. 7-8, 11A and 11B).

In at least one example embodiment, other shape of the consumer product 105 are contemplated. In at least one example embodiment, the consumer product 105 has a footprint (horizontal cross-section) that is square, rectangular, triangular, hexagonal, or another polygonal shape (not shown). In at least one example embodiment, the horizontal cross-section 715 of the cutouts 510 match the footprint 710 of the consumer products 105, where at least the back portion 705 of the cutouts 510 is an imprint of a portion of the consumer product 105. In at least one example embodiment, if the footprint 710 of the consumer products 105 is something other than circular, the first conveyor 110 and/or the feed tray 130 may include mechanical, pneumatic, hydraulic, magnetic, robotic and/or electronic devices or structure that ensure the consumer products 105 are loaded onto the feed tray 130 in a proper orientation to ensure the consumer products 105 are properly oriented while loaded into the cutouts 510 of the wheel 500.

In at least one example embodiment, the base structure 530 is a plate, or a layer of plates and material. In at least one example embodiment, the base structure 530 is an integral part of the wheel 500. In at least one example embodiment, the base structure 530 defines the bottom surface 515 of the cutouts 510. In at least one example embodiment, a footprint of the base structure 530 corresponds to a footprint of the body 506 of the wheel 500. In at least one example embodiment, the base structure 530 has a footprint that is circular, ring-shaped or donut-shaped.

In at least one example embodiment, a drive 540 is connected to at least a portion of the base structure 530 (see FIGS. 7 and 8). In at least one example embodiment, the drive 540 is a worm drive, a ball screw drive, a threadless ball screw drive, a rolling pin drive, a roller connected to a belt or a conveyance mechanism, or another type of drive that imparts a rotational force onto the base structure 530, or onto another portion of the wheel 500 to rotate the wheel 500 and the base structure 530. In at least one example embodiment, the base structure 530 defines an aperture 800 (FIG. 8) that allows at least part of the drive 540 (FIG. 7) to extend through a main portion of the wheel 500 and through an upper portion of a cam plate 555 (FIG. 7) of the wheel 500. In at least one example embodiment, a collar 740 can be connected to an upper end of the drive 540 (FIGS. 7 and 10A). In at least one example embodiment, the collar 740 is securely affixed to an upper surface of the cam plate 555 and allows the drive 540 to rotate within the collar 740, or alternatively the collar 740 can be free to rotate with the drive 540 and remain unconnected to the cam plate 555.

In at least one example embodiment, the back portion 705 of each of the cutouts 510 includes a notch 524. In at least one example embodiment, the notch 524 extends vertically along at least part of a height of the back portion 705 of the cutout 510, where the notch 524 houses at least a portion of a piston (rod) 528 that is used to discharge each of the stacks 155 from the cutouts 510 (see at least FIG. 11A), as explained in more detail herein. In at least one example embodiment, the notch 524 has a U-shaped horizontal cross-section (as shown in FIGS. 7 and 8).

In at least one example embodiment, the piston 528 is configured to move between a retracted position (see at least the first cutout 510a at a first position 770, shown in FIG. 7) and an extended position (see at least the second cutout 510b in a second unloading location 700, shown in FIG. 7), as discussed herein in more detail. In at least one example embodiment, when moving from the retracted to the extended position, the piston 528 contacts at least a side of the stack 155 to shift the stack 155 from the cutout 510 and unload the stack 155 at the second unloading location (a “second position” of cutout 510b) 700, shown in at least FIG. 7. In at least one example embodiment, other configurations of the piston 528 are envisioned.

In at least one example embodiment, a discharge device 1710 that is near or within each of the pockets 512 may be used to discharge the stacks 155 (see at least FIG. 17). In at least one example embodiment, the discharge device 1710 is used in lieu of, or in conjunction with, the piston 528 and the rod 735 in order to discharge the stacks 155. A further discussion of the discharge device 1710 is included in conjunction with the description of FIG. 17.

In at least one example embodiment, the cam plate 555 extends over at least a portion of an upper part of the wheel 500 (see at least FIG. 7), where the cam plate 555 remains in a fixed position during an operation of the wheel 500. In at least one example embodiment, the cam plate 555 is bolted into the fixed position via bolts 725 or other structure that may be connected to the housing 550 or other fixed structure that does not rotate during an operation of the wheel 500. In at least one example embodiment, the cam plate 555 is at least partially supported or connected to the drive 540 via the collar 740. In at least one example embodiment, the cam plate 555 can optionally be an integral part of the housing 550. In at least one example embodiment, the cam 900 is connected to the cam plate 555 via anchors 720 (see FIGS. 7-9), where the anchors 720 hold the cam 900 into the fixed position in a central location of the wheel 500 during the operation of the wheel 500. In at least one example embodiment, the cam 900 (FIGS. 7-9) is an eccentric cam with a circular but distorted shape, as explained herein in more detail. In at least one example embodiment, the cam 900 includes a circular portion 930 that has a circular shape from an overhead perspective, where the cam 900 is mounted on the wheel 500 such that an approximate epicenter of the circular portion 930 is also an epicenter of the wheel 500 (see FIGS. 8 and 9). In at least one example embodiment, the cam 900 includes an extended portion 920 that causes a portion of the cam 900 to jut out and away from the epicenter 925 (FIGS. 8 and 9). In at least one example embodiment, the cam 900 is mounted on the wheel 500 such that a first end 935 of the extended portion 920 is near the second unloading location 700 (FIG. 8).

In at least one example embodiment, a rod 735 is connected to at least a portion of the piston 528 (see at least FIGS. 7-8, 10A, 10B and 10C). In at least one example embodiment, a bumper 730 is affixed to a distal end 765 of each one of the rods 735, where the bumper 730 contacts and rides along an interior surface 910 of the cam 900 as the rods 735 rotate with the body 506 when the wheel 500 is in operational use (see FIGS. 8-9, 10B and 10C, in particular). In at least one example embodiment, springs 755 are operationally connected to each one of the rods 735 to ensure the piston 528 is properly extended radially outward from within the cutout 510, at a point where each cutout 510 approaches the second unloading location (second discharge location) 700 of the wheel 500 (see the position of the rod 735 and extended piston 528 at the second unloading location 700 of FIGS. 7-8, 10A, 10B, 10C and 11B).

In at least one example embodiment, each one of the rods 735 includes two of the springs 755, on either side of the rod 735 (see FIGS. 7 and 8). In at least one example embodiment, a first end of each of the springs 755 is operatively connected to a mounting collar 750 (FIGS. 7-8 and 10B), where the mounting collar 750 is supported by, and rotates on, the base structure 530 when the wheel 500 is rotating and is in operational use. In at least one example embodiment, the first end of the spring 755 is anchored to a vertical pin 1010, where the vertical pin 1010 is anchored to the mounting collar 750 (see FIGS. 10B and 10C). In at least one example embodiment, a second end of each of the springs 755 is operatively connected to the distal end 765 of the rod 735. In at least one example embodiment, the second end of the springs 755 are connected to a wire 760, where the wire 760 is connected to a horizontal pin 1015 on the distal end 765 of the rod 735 (see at least FIGS. 10B and 10C). In at least one example embodiment, the body 506 defines a step 745 (FIGS. 10A, 11A and 11B), where an underside of the step 745 assists in stabilizing a movement of the rod 735 during an operational movement of the wheel 500, as described in more detail below. In at least one example embodiment, a position and a force of the springs 755 causes the rods 735 to slide within grooves 1020 that are defined within the base structure 530 while the wheel 500 is in operational use, as described herein in more detail.

### Operational Movement of Wheel

In at least one example embodiment, during an operational movement (rotation) of the wheel 500, the base structure 530 rotates, and the body 506 and the rods 735 remain supported by the base structure 530 such that the body 506 and the rods 735 rotate with the base structure 530 (see at least FIGS. 7 and 8). In at least one example embodiment, and as explained above, the cam 900 remains stationary and does not rotate with the base structure 530. In at least one example embodiment, as the wheel rotates 500, the springs 755 maintain tension on the rods 735 and pull each of the rods 735 radially outward and towards the mounting collar 750, as the bumpers 730 on the distal end 765 of the rods 735 stay pressed against the interior surface 910 of the cam 900 (see FIGS. 8, 10B and 10C). In at least one example embodiment, as the rods 735 rotate into the first position 770 (as shown in FIGS. 8, 10B and 10C), a force from the springs 755 maintain a tension on the horizontal pins 1015 that pull the rods 735 in a radially outward direction away from a radial center of the base structure 530 (e.g., away from the aperture 800), as the bumpers 730 keep the distal end 765 of the rods 735 anchored on the cam 900. Due to the eccentric (distorted) shape of the cam 900, in the first position 770 the cam 900 is relatively further apart from the mounting collar 750 which causes the distal ends 765 of the rods 735 to slide within the grooves 1020 closer to the radial center of the base structure 530, which in turn causes the piston 528 on a proximal end 775 of the rods 735 to be retracted within the notch 524 when the cutouts 510 are in the first position 770 (see FIGS. 8, 10A and 10B). In at least one example embodiment, as the cutouts 510 rotate around to the second unloading location 700, the springs 755 pull the rods 735 radially outward due to the eccentric shape of the cam 900 (where the cam 900 is closer to the mounting collar 750 at the second unloading location 700), thereby causing the piston 528 to move into an extended position and push the stack 155 of the consumer products 105 out of the second cutout 510b to discharge the stack 155 from the wheel 500 (see at least FIGS. 8, 10A and 11B).

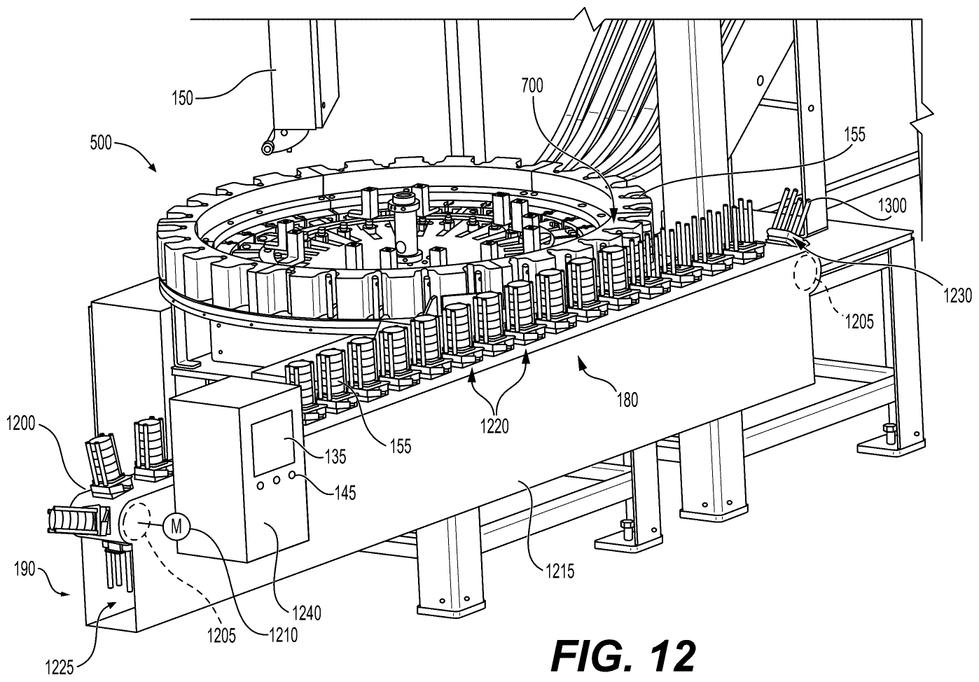

FIG. 12 is an illustration of a perspective view of the wheel 500 and the second conveyor 180 of the system 100 (with the wheel 500 shown without the housing 550), in accordance with at least one example embodiment.

In at least one example embodiment, the wheel 500 discharges the stacks 155 at the second unloading location 700 onto the second conveyor 180. In at least one example embodiment, the second conveyor 180 includes a belt 1200. In at least one example embodiment, belt 1200 is an endless belt that runs on one or more rollers 1205. In at least one example embodiment, one or more motors 1210 power movement of the one or more rollers 1205 and/or the belt 1200. In at least one example embodiment, holders 1220 are affixed to the belt 1200. In at least one example embodiment, the belt 1200 and the holders 1220 are at least partially enclosed by a housing 1215. In at least one example embodiment, the housing 1215 defines a cavity 1225 that allows the holders 1220 to travel in an upside-down orientation through the housing 1215 to be returned to a first position 1230 on an end of the second conveyor 180 after the stacks 155 are discharged in the first unloading location 190. In at least one example embodiment, one or more user control devices 1240, which may be in addition to or in lieu of the user control device 150 (FIG. 1), can be used to control operations of the second conveyor 180 and/or other elements of the system 100.

FIG. 13A is an illustration of a perspective view of the second conveyor 180, in accordance with at least one example embodiment. FIG. 13B is an illustration of the holder 1220 of the second conveyor 180, in accordance with at least one example embodiment. FIG. 13C is an illustration of the holder 1220 holding the stack 155 of the consumer products 105, in accordance with at least one example embodiment. FIG. FIG. 13D is an illustration of the holder 1220 holding the stack 155 of the consumer products 105 with the guards 1300 in an extended position 1375 away from the stack 155, in accordance with at least one example embodiment. FIG. 13E is an illustration of the holder 1220 holding the stack 155 of the consumer products 105 with the guards 1300 in a retracted (normal) position 1380, in accordance with at least one example embodiment. FIG. 13F is an illustration of the holder holding the stack 155 of the consumer products 105 with a barrier material 1335 fitted around the stack 155, in accordance with at least one example embodiment.

In at least one example embodiment, each of the holders 1220 includes a plate 1305. In at least one example embodiment, at least a central portion of an underside of each of the plates 1305 is affixed to the belt 1200 by an anchor point 1365 (see at least FIG. 13B), where ends 1310 of the plate can remain unconnected from the belt 1200 to allow the holders 1220 to pivot on the belt 1200 (see second position 1315 of the holder 1220 pivoting on the belt 1200, to tilt the holder 1220 near the first unloading location 190, in at least FIG. 13A). In at least one example embodiment, each of the holders 1220 includes guards (pegs, posts, or “stabilizer rods”) 1300 that are operatively connected to the plate 1305. In at least one example embodiment, the guards 1300 are used to receive and hold the stacks 155. In at least one example embodiment, each of the holders 1220 includes four of the guards 1300. In at least one example embodiment, each of the holders 1220 includes two or three of the guards 1300, or each of the holders 1220 includes five or more of the guards 1300. In at least one example embodiment, a base 1320 is operatively connected to the plate 1305 of each of the holders 1220. In at least one example embodiment, an insert (projection) 1325 extends from a central portion of the base 1320 (see at least FIG. 13B). In at least one example embodiment, the insert 1325 and the base 1320 provide a receiving surface 1330 for the stacks 155 being loaded onto the holders 1220, and the guards 1300 hold the stacks 155 on at least part of the receiving surface 1330. In at least one example embodiment, the insert 1325 can vary in size and geometry, where the insert 1325 can fit into a recessed area 2500 defined by the lower surface 2310 of the consumer products 105 (see FIGS. 13C and 23).

In at least one example embodiment, the guards 1300, the plate 1305, a base structure 1370 for the guards 1300, or another portion of the holder 1220 can include one or more kinetic devices 1340 that are capable of actuating the guards 1300 to move, shift and/or tilt each of the guards 1300 in a direction of movement 1360 that is away from the insert 1325 so that the guards 1300 are in the “extended position” 1375 (see at least FIGS. 13B and 13D). In at least one example embodiment, the one or more kinetic devices 1340 can retract the guards 1300 back into a retracted (normal) position 1380 so the guards 1300 can grip the stack 155 (see FIG. 13D). In at least one example embodiment, when the holders 1220 are at the first unloading location 190 and/or the second unloading location 700, the one or more kinetic devices 1340 can move the guards 1300 into an extended position 1375 to allow the stack 155 to either be fitted onto the insert 1325 or allow the stack 155 to be removed from the insert 1325. In at least one example embodiment, when the holders 1220 are in transit between the second unloading location 700 and the first unloading location 190, the one or more kinetic devices 1340 can move the guards 1300 to the retracted position 1380 so that the guards 1300 grip the stacks 155 to ensure the stacks 155 remain on the holders 1220. In at least one example embodiment, the one or more kinetic devices 1340 can include piezoelectric devices, springs, magnets, motors, pneumatic or hydraulic devices, etc.

In at least one example embodiment, the holders 1220 do not include the one or more kinetic devices 1340, and instead the guards 1300 of the holders 1220 are moved by other mechanical or manual means (e.g., robotic arms, robots, etc.) from the extended position 1375 to the retracted position 1380. In at least one example embodiment, the guards 1300 are made from a flexible and/or resilient material that allows the guards 1300 to be flexed and/or bent. In at least one example embodiment, a physical weight of the stack 155 causes the guards 1300 to separate slightly as the stack 155 is loaded onto the holder 1220 at the second unloading location 700, and the physical weight of the stack 155 again causes the guards 1300 to separate slightly as the stack 155 is ejected from the holder 1220 at the first unloading location 190. In at least one example embodiment, the guards 1300 are made from a stiff material and are therefore not flexible or resilient, but are able to be separated by some or all of the methods or devices described above. In at least one example embodiment, any combination of the features of the guards 1300, as described herein, may be implemented. Other well-known configurations of the guards 1300 are contemplated.

In at least one example embodiment, and as shown in FIG. 13F, the barrier material 1335 can be placed over the stack 155 while the stack 155 is held within the holder 1220. In at least one example embodiment, the barrier material 1335 is fitted over the stack 155 and between the guards 1300, while the stack 155 remains on the second conveyor 180. In at least one example embodiment, the guards 1300 of the holder 1220 are in the extended position 1375 while the barrier material 1335 is being placed over the stack 155, where this may be accomplished at the second unloading location 700, or at another location on the second conveyor 180.

In at least one example embodiment, a robotic or a robotic arm, applies the barrier material 1335 over the stack 155. In at least one example embodiment, the barrier material 1335 is applied to the stack 155 manually, or the application of the barrier material 1335 is at least assisted through manual means. Other means of applying the barrier material 1335 over the stack 155 is contemplated. In at least one example embodiment, the barrier material 1335 is applied to the stack 155 while the stack is in the heat tunnel 175 (see FIG. 1). In at least one example embodiment, the barrier material 1335 is a polymer plastic film made from polyethylene, polypropylene and/or polyvinyl chloride (PVC). In at least one example embodiment, the barrier material 1335 is a sheet of material made from regenerated cellulose or pressure sensitive tape that may or may not be coated with a nitrocellulose lacquer. In at least one example embodiment, the barrier material is a “shrink wrap” material, or another suitable type of material that is capable of shrinking and/or adhering to the stacks 155, especially following an application of heat and/or light after the barrier material 1335 covers at least part of the stack 155. In at least one example embodiment, the barrier material 1335 includes one or more layers of material that is loosely fitted over the stacks 155, where the barrier material 1335 is then heated to activate and/or “shrink” the barrier material 1335 and cause the barrier material 1335 to adhere to at least a portion of the stack 155. In at least one example embodiment, the heat tunnel 175 has heaters, a heat-blower, lights or other elements (not shown) that are capable of heating the barrier material 1335 to activate and/or “shrink” the barrier material 1335, once the barrier material 1335 covers at least a portion of the stack 155. In at least one example embodiment, the barrier material 1335 is a stretch wrap material that can be stretched over the stack 155 to adhere to the stack 155, either with or without an application of heat. Other means of adhering the barrier material 1335 to the stack 155, while the stack 155 is on the second conveyor 180, is contemplated.

In at least one example embodiment, the barrier material 1335 is not added to and/or covering the stack 155. In at least one example embodiment, at least one of a clip, one or more adhesive strips, a splint, a rod, or other structure is applied to and/or contacts side surfaces of the stack 155 to hold the consumer products 105 of the stack 155 together, prior to the stacks 155 being discharged at the first unloading location 190.

In at least one example embodiment, the discharge device 1710 can be included on the holders 1220 to assist in the discharge of the stacks 155 from the holders 1220. In at least one example embodiment, the discharge device 1710 can be included in or on the receiving surface 1330, the base 1320 and/or the insert 1325 of the holders 1220. A further discussion of the discharge device 1710 is included in the description of FIG. 17.

FIG. 14 an illustration of a user control arrangement 1400, in accordance with at least one example embodiment.

Referring to FIG. 14, in at least one example embodiment, the user control arrangement 1400 includes at least one processor 1410 that is operatively connected to one or more of the elements shown in FIG. 14 to control one or more of the operations of the system 100, as described herein. In at least one example embodiment, the at least one processor 1410 is included in, or the processor interfaces with, the user control device 150 (FIG. 1), the one or more user control devices 1240 (FIG. 12), and any of the elements of the system 100 (FIG. 1) and/or the system 100a (FIG. 16).

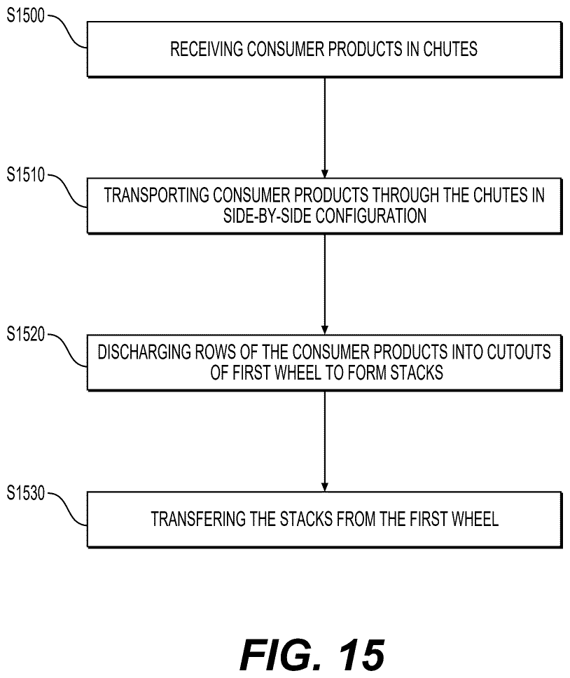

In at least one example embodiment, the at least one processor 1410 is operatively connected to a memory 1450, where the memory 1450 stores executable instructions that the at least one processor 1410 uses to operate one or more of the elements or operations of the systems 100/100a (see FIGS. 1 and 16), as described herein. In at least one example embodiment, the memory 1450 stores executable instructions that the at least one processor 1410 uses to perform the method included in FIG. 15. In at least one example embodiment, the at least one processor 1410 is operatively connected to the user input 145 and/or the GUI 135, via at least one communication bus 1420, to allow users to selectively control at least some aspects of the system 100 and/or view various information for the system 100 that is compiled and displayed by the user control arrangement 1400.

In at least one example embodiment, the at least one processor 1410 is operative connected to one or more sensors 1430 connected to various elements of the systems 100/100a. In at least one example embodiment, the one or more sensors 1430 includes a speed sensor, a motion sensor, a rotary sensor, a limit switch sensor, or other well-known sensors for controlling the system 100 or various elements of the systems 100/100a. In at least one example embodiment, the one or more sensors 1430 senses a motion of the consumer products 105 and/or stacks 155 on the first conveyor 110, various locations of the feed tray 130, at locations on the wheel 500, at the second unloading location 700, on the second conveyor 180 and/or at the first unloading location 190. In at least one example embodiment, the one or more sensors 1430 sense a rotational speed of the wheel 500 and/or the rollers 1205, or the one or more sensors 1430 sense a linear speed of movement of the belt 1200 of the second conveyor 180. Likewise, in at least one example embodiment, the one or sensors 1430 may be arranged to sense parameters such as a rotational speed and a movement of the stacks 155 and/or the consumer products 105 on a second wheel 500a, or on other elements that are included in the system 100a (FIG. 16).

In at least one example embodiment, the at least one processor 1410 is operatively connected to one or more cameras 1460 that are stationed at locations throughout the systems 100/100a. In at least one example embodiment, the memory 1450 includes executable instructions that the at least one processor 1410 uses to digitally process photos and/or video signals from the one or more cameras 1460, as described herein. In at least one example embodiment, the at least one processor 1410 receives digital information (e.g., photos and/or video from the one or more cameras 1460), and based on the digital information the at least one processor 1410 can confirm or determine if the consumer products 105 and/or stacks 155 are properly flowing through at least some of the following: the first conveyor 110, one or more of the chutes 200 of the feed tray 130, the cutouts 510 of the wheels 500/500a, the second unloading location 700, the second conveyor 180, and the first unloading location 190. In at least one example embodiment, the at least one processor 1410 uses the digital information to confirm or determine potential defects regarding labeling on the consumer products 105 and/or the stacks 155, proper or improper orientation of the consumer products 105 and/or stacks 155 that are entering, exiting and/or on the wheels 500/500a, proper or improper orientation and outer wrapping (e.g., placement of the barrier material 1335) for the stacks 155 that are entering, exiting and/or on the second conveyor 180, jamming or flow problems at any location within the systems 100/100a, etc. In at least one example embodiment, the at least one processor 1410 can take corrective action within the systems 100/100a, speed up or slow down some or all of the operations of the systems 100/100a, and/or catalogue time-stamped information based on the digital information. In at least one example embodiment, the at least one processor 1410 causes at least some of the digital information to be displayed on the GUI 135.

In at least one example embodiment, the at least one processor 1410 is operatively connected to motors 1470 (e.g., motors 120, 132 and 1210) and/or actuators 1455 of the systems 100/100a. In at least one example embodiment, the memory 1450 includes executable instructions that the at least one processor 1410 uses to control the motors 1470 and/or the actuators 1455, where this control function can be based at least in part on the digital information and/or signals from the one or more cameras 1460, the user input 145 and/or the sensors 1430. In at least one example embodiment, the actuators 1455 are associated with any of the robotic, pneumatic, hydraulic, piezoelectric, magnetic and/or solenoid-operated devices described herein. In at least one example embodiment, the at least one processor 1410 controls and/or harmonizes movement and a speed of operation of the consumer products 105 and/or the stacks 155 traveling along the first conveyor 110, flowing through the feed tray 130, being received at the wheels 500/500a, traveling on the wheels 500/500a, being discharged at the second unloading location 700 (or other unloading locations described in association with the systems 100/100a), being loaded onto the second conveyor 180, and being discharged at the first unloading location 190. In at least one example embodiment, the at least one processor 1410 harmonizes a speed of operation between a rotational speed of the wheels 500/500a and a movement and speed of the first conveyor 110 and the second conveyor 180. In at least one example embodiment, the at least one processor 1410 causes the motors 1470 and/or the actuators 1455 to cause the wheels 500/500a, the first conveyor 110 and/or the second conveyor 180 to operate using staggered movement (non-continuous) and/or continuous motion, or transition between staggered and continuous motion. In at least one example embodiment, the at least one processor 1410 causes the motors 1470 and/or the actuators 1455 to reposition, reorient and/or remove (reject) the consumer products 105 and/or the stacks 155 that may be jammed, defective and/or in an improper orientation. Other implementations of a control scheme that the at least one processor 1410 uses to control the motors 1470 and/or the actuators 1455 is contemplated.

In at least one example embodiment, the user control arrangement 1400 includes a network interface 1440. In at least one example embodiment, the network interface 1440 may be used to connect one or more of the elements of the user control arrangement 1400 to each other. In at least one example embodiment, the network interface 1440 is used to connect the sensors 1430 and/or the user input 145 to the at least one processor 1410. In at least one example embodiment, the network interface 1440 may be connected to a server over a network, and the network may include a wireless network capable of sending and receiving wireless signals 1445, such as a cellular wireless access network (e.g., a 3G wireless access network, a 4G-Long Term Evolution (LTE) network, or a 5G-New Radio (e.g., 5G) wireless network, a WiFi network, a satellite network, etc.). In at least one example embodiment, the network can include a wired network (e.g., a fiber network, a cable network, a PTSN, etc.). The server may connect to other servers (not shown), over a wired and/or wireless network, and the user control arrangement 1400 may connect to other user devices over a wired and/or wireless network. The network may refer to the Internet, an intranet, a wide area network, etc.

In at least one example embodiment, the at least one communication bus 1420 may enable communication and/or data transmission to be performed between elements of the user control arrangement 1400. The at least one communication bus 1420 may be implemented using a high-speed serial bus, a parallel bus, and/or any other appropriate communication technology. According to some example embodiments, the user control arrangement 1400 may include a plurality of communication buses.

While FIG. 14 depicts an example embodiment of the user control arrangement 1400, the user control arrangement 1400 is not limited thereto, and may include additional and/or alternative architectures that may be suitable for the purposes demonstrated. For example, the functionality of the user control arrangement 1400 may be divided among a plurality of physical, logical, and/or virtual server and/or computing devices, network elements, etc., and the example embodiments are not limited thereto.

FIG. 15 is a method flowchart for using a system to form the stacks 155 of consumer products 105, in accordance with at least one example embodiment.

In at least one example embodiment, step S1500 of the method includes receiving the consumer products 105 in the chutes 200. In at least one example embodiment, step S1510 includes transporting the consumer products 105 through the chutes 200 in a side-by-side configuration (from an overhead view, as shown in at least FIGS. 1, 5 and 17). In at least one example embodiment, step S1520 includes discharging rows of the consumer products 105 into the cutouts 510 of the wheel (“first wheel”) 500 to form the stacks 155. In at least one example embodiment, step S1520 includes discharging each of the rows of the consumer products 105 at different (unique) elevations into the cutouts 510 of the wheel 500. In at least one example embodiment, step S1530 includes transferring the stacks 155 from the wheel 500.

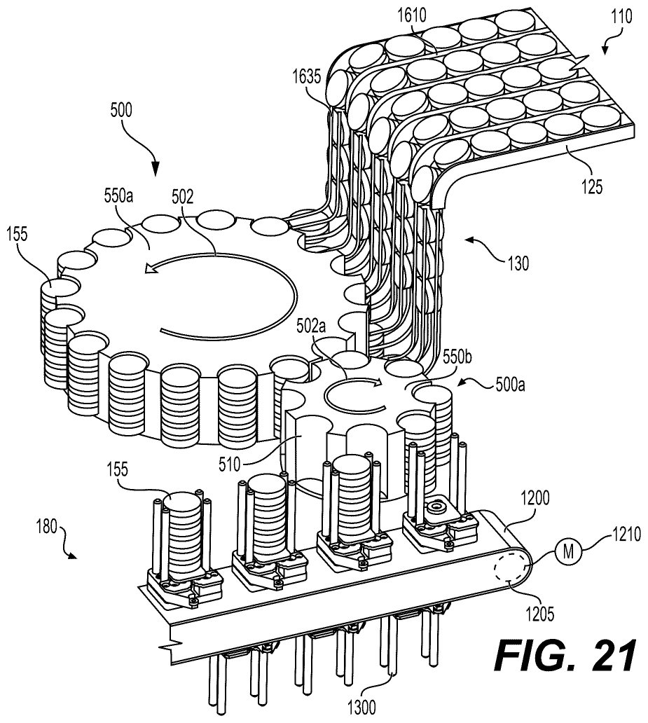

FIG. 16 is an illustration of a perspective view of a system 100a, in accordance with at least one example embodiment. FIG. 17 is an illustration of an overhead view of the system 100a, in accordance with at least one example embodiment. FIGS. 18-21 are illustrations of side and perspective views of the system 100a, in accordance with at least one example embodiment.

In at least one example embodiment, the system 100a shown in FIGS. 16 and 17 is the same as the system 100 of FIG. 1, with exceptions and/or additional detail regarding this example embodiment described herein. In at least one example embodiment, the system 100a includes the second wheel 500a. In at least one example embodiment, the second wheel 500a receives the stacks 155 of the consumer products 105 from the wheel 500 at a third unloading location 1700 (see an interface between the first wheel 500 and the second wheel 500a in FIG. 17), where the second wheel 500a discharges the stacks 155 at the second unloading location 700 onto the second conveyor 180, in a manner that is the same as that which is described in association with the system 100 shown in at least FIG. 8.

In at least one example embodiment, the first conveyor 110 includes inner rails (a “first structure”) 1610 on or near the first end 154 of the first conveyor 110, where the inner rails 1610 help divide the consumer products 105 into the chutes (channels, lanes or “travel paths”) 200 to cause the consumer products 105 to enter the feed tray 130 in side-by-side rows. In at least one example embodiment, the feed tray 130 includes rails 1635 that further define the chutes 200 that load the consumer products 105 onto the first wheel 500. That is to say, in at least one example embodiment, the chutes 200 are defined by both the feed tray 130 and at least a portion of the first conveyor 110. In at least one example embodiment, the feed tray 130 defines the chutes 200 to be shorter or longer than the chutes 200 that are generally depicted in FIG. 16 (as well as the chutes 200 depicted in at least FIG. 4B). In at least one example embodiment, each of the chutes 200 has a high capacity requiring only intermittent charging of the consumer products 105 within the feed tray 130. In at least one example embodiment, the chutes 200 can have various shapes that cause the consumer products 105 to travel in either a downward direction, a declined direction, and/or a horizontal direction prior to the chutes 200 discharging the consumer products 105 onto the first wheel 500. In at least another example embodiment, the first conveyor 110 does not include the inner rails 1610, and instead the consumer products 105 are corralled into the side-by-side rows once the consumer products 105 enter the feed tray 130 at the first end 154 of the first conveyor 110. Other structure for loading the consumer products 105 into the chutes 200, and other structure for the first conveyor 110 and/or the feed tray 130 are contemplated.

In at least one example embodiment, the rails 1635 of the feed tray 130 allow a movement of the consumer products 105 to be visually monitored from several perspectives that are external to the feed tray 130 (as shown in FIGS. 16 and 19-21). In at least one example embodiment, spacing between the rails 1635 allow the consumer products 105 to be manually cleared, or cleared by a robotic arm or other mechanical and/or pneumatic means (e.g., a piston, a jet of air pressure, etc.), in the event any of the chutes 200 become jammed during an operation of the system 100.

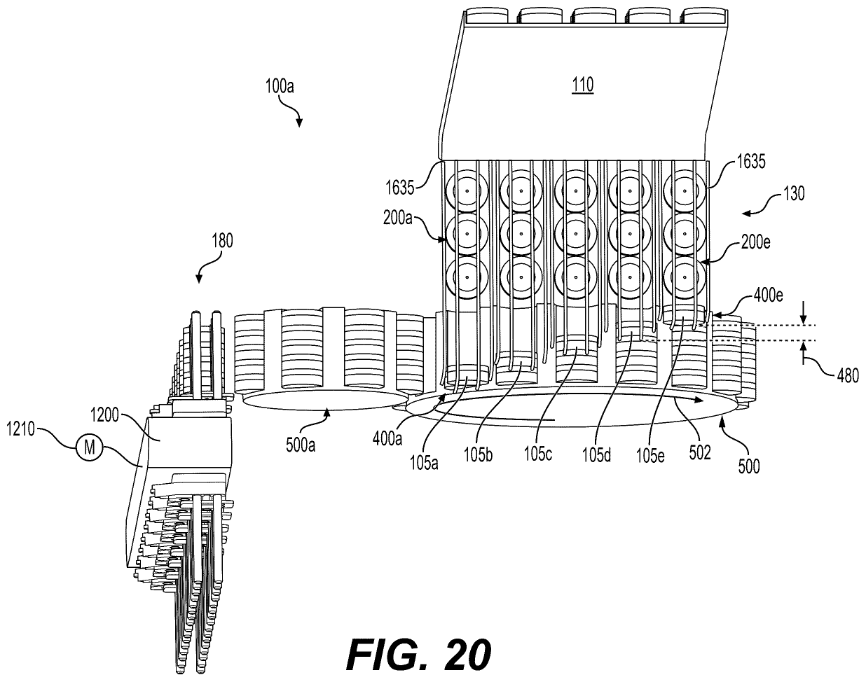

In at least one example embodiment, the rotational direction 502 of the first wheel 500 rotates in a direction that may be opposite that which is shown in FIGS. 7 and 8. That is to say, in at least one example embodiment, the rotational direction 502 of the first wheel 500 is a counter-clockwise direction from an overhead perspective (see at least FIG. 17). In at least one example embodiment, because the rotational direction 502 of the first wheel 500 is counter-clockwise, the first chute 200a is on an opposite side of the feed tray 130 (as shown in FIGS. 16 and 17), relative to a location of the first chute 200a in the feed tray 130 shown in FIGS. 2 and 5. Specifically, in at least one example embodiment, the first outlet 400a of the first chute 200a has a lowest elevation of the outlets 400 (see FIG. 20), where the first outlet 400a load the consumer products 105 onto the first wheel 500 first, and each of the outlets 400 of the feed tray 130 successively load the cutouts 510 in order until the fifth outlet 400e of the fifth chute 200e loads the final (top-most) consumer product 105 onto each one of the stacks 155 (best shown in FIG. 20). In at least one example embodiment, the fifth outlet 400e of the fifth chute 200e is at a highest elevation of the outlets 400 (FIG. 20).

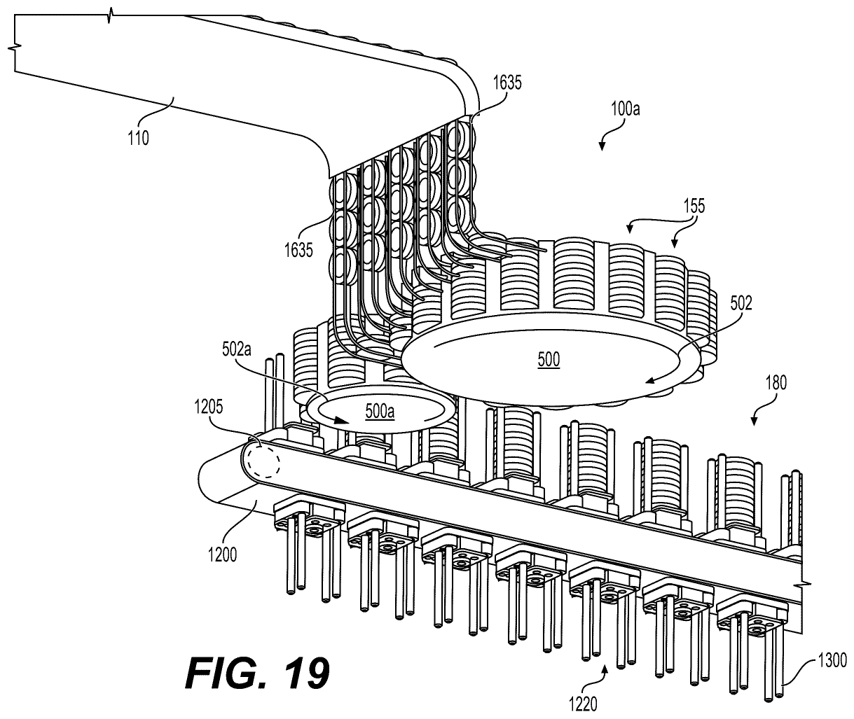

In at least one example embodiment, the second wheel 500a rotates in a horizontal plane (e.g., a plane that is perpendicular to gravity) that is in a same plane as the horizontal plane which the first wheel 500 rotates within. In at least one example embodiment, a rotational direction 502a of the second wheel 500a is opposite the rotational direction 502 of the first wheel 500. That is to say, in at least one example embodiment, if the rotational direction 502 of the first wheel 500 is counter-clockwise from an overhead perspective (as shown in FIGS. 16 and 17), the rotational direction 502a of the second wheel 500a is clockwise. In at least one example embodiment, the rotational directions 502/502a may be reversed (relative to what is shown in FIGS. 16 and 17), such that the rotational direction 502 of the first wheel 500 is clockwise and the rotational direction 502a of the second wheel 500a is counter-clockwise, where such an embodiment would necessitate reversing the elevational changes of the outlets 400 of the chutes 200 (FIGS. 19 and 20), as the consumer products 105 would be loaded onto the first wheel 500 in an opposite order from that which is shown in the system 100a of FIGS. 16 and 17 (e.g., the position of the first chute 200a and the fifth chute 200e would be reversed).

In at least one example embodiment, with the rotational direction 502 of the first wheel 500 being counter-clockwise, the stacks 155 have a longer travel distance while being transported on the first wheel 500, such that there are a greater number of inspection locations 1720 (e.g., potential locations for the stacks 155, or the consumer products 105 on the stacks 155, to be inspected), relative to if the rotational direction 502 is clockwise. In at least one example embodiment, video equipment, time-lapse visual recording devices, or other visual devices (summarized here as “cameras”) may be positioned at or near the inspection locations 1720, where robotic arms, robots, hydraulic and/or pneumatic devices may potentially be included to remove any of the consumer products 105 and/or the stacks 155 that may have defects in labeling and/or orientation. In at least one example embodiment, a relative size, an arrangement and/or a position of the major elements of the system 100a (e.g., the first conveyor 110, the feed tray 130, the first wheel 500, the second wheel 500a and the second conveyor 180), can be different than that shown in FIG. 17 to fit a footprint of a building and/or maximize an inspection potential, etc. For example, in at least one example embodiment, the second conveyor 180 may be located on the other side 1730 of the first conveyor 110, where in such a configuration the rotational direction 502 of the first wheel 500 may be reversed to maximize a number of the inspection locations 1720. Other inspection equipment and other means of inspection, including adjustments to a speed of rotation of the first wheel 500 and the second wheel 500a, are contemplated.

In at least one example embodiment, the movement (rotation) of the first wheel 500 and the second wheel 500a are coordinated by the at least one processor 1410 (FIG. 14), such that the cutouts (“first set of cutouts”) 510 of the first wheel 500 and the cutouts (“second set of cutout”) 510 of the second wheel 500a rotate in unison (regular alignment). With this unified movement of the first wheel 500 and the second wheel 500a, as each one of the cutouts 510 comes into alignment with each other, the aligned cutouts 510 are at least momentarily adjacent to each other, thereby facilitating a transfer of the stacks 155 at the third unloading location (third discharge location) 1700.

In at least one example embodiment, the movement of the second wheel 500a is coordinated (aligned) with the second conveyor 180 by the at least one processor 1410 (FIG. 14), such that the cutouts 510 of the second wheel 500a are at least momentarily aligned with a respective one of the holders 1220 (see the holder 1220 at the second unloading location 700 in FIG. 17), as the second wheel 500a rotates and the second conveyor 180 conveys the holders 1220. This coordinated movement allows each one of the cutouts 510 of the second wheel 500a to be at least momentarily adjacent to one of the holders 1220, thereby facilitating a transfer of the stacks 155 at the second unloading location 700. In at least one example embodiment, the system 100a does not include the second wheel 500a, whereupon the at least one processor 1410 would coordinate alignment of the cutouts 510 of the first wheel 500 with the holders 1220 of the second conveyor 180 to effectively transfer the stacks 155 onto the second conveyor 180 (just as the at least one processor 1410 does in the system 100 of FIG. 1).

In at least one example embodiment, the movement of the first conveyor 110, the second conveyor 180, the first wheel 500 and/or the second wheel 500a are smooth and continuous, such that the first conveyor 110, the second conveyor 180, the first wheel 500 and the second wheel 500a move at a substantially uniform and continuous speeds for extended durations of time. In at least one example embodiment, the movement of the first conveyor 110, the second conveyor 180, the first wheel 500 and/or the second wheel 500a are non-continuous, such that the first conveyor 110, the second conveyor 180, the first wheel 500 and/or the second wheel 500a are momentarily slowed or stopped during periods. In at least one example embodiment, a momentary and/or instantaneous slowing and/or stopping of the first conveyor 110, the second conveyor 180, the first wheel 500 and/or the second wheel 500a occur when the stacks 155 are discharged at the third unloading location 1700 and/or the second unloading location 700. In at least one example embodiment, the momentarily and/or instantaneous slowing or stopping movement of the first conveyor 110, the second conveyor 180, the first wheel 500 and/or the second wheel 500a may assist in allowing opportunities of time for the stacks 155, or the consumer products 105 on the stacks 155, to be inspect, removed and/or adjusted (re-oriented, etc.), as described above.

In at least one example embodiment, at the second unloading location 700 a direction of movement 1740 of the holders 1220 of the second conveyor 180 and the cutouts 510 of the second wheel 500a are generally the same. That is to say, at the second unloading location 700, the rotational direction 502a of the second wheel 500a is clockwise, which causes the cutouts 510 of the second wheel 500a to move in the direction of movement 1740 that coincides with movement of the belt 1200 of the second conveyor (FIG. 17), where the cutouts 510 and the holders 1220 at the second unloading location 700 are timed to at least momentarily move together in the direction of movement 1740. This provides an opportunity for the stacks 155 to be more effectively transferred at the second unloading location 700 (where this also applies to a movement of the cutouts 510 of the first wheel 500 at the second unloading location 700 of the system 100 in at least FIG. 8).

In at least one example embodiment, the first wheel 500 and the second wheel 500a include a first housing 550a and a second housing 550b, respectively, that are “partially open,” from the standpoint that the first housing 550a and the second housing 550b leave the cutouts 510 exposed and able to be visually inspected from sides of the first wheel 500 and the second wheel 500a during an operation of the system 100a. In at least one example embodiment, the first housing 550a and the second housing 550b cover and protect internal elements of the first wheel 500 and the second wheel 550b, where the internal elements may for instance include the internal elements shown in the wheel 500 of FIGS. 8, 10B and 10C. In at least one example embodiment, the “partially open” configuration of the first housing 550a and the second housing 550b can be used in conjunction with the inspection locations 1720 of the system 100a (FIG. 17) to provide an increased level of inspection opportunities and/or a re-orientation or removal of the consumer products 105 and/or the stacks 155 on the first wheel 500 and/or the second wheel 500a.

In at least one example embodiment, the discharge device 1710 can be included within or around the cutouts 510 of the first wheel 500 and/or the second wheel 500a (FIG. 17) to discharge the stacks 155 from the first wheel 500 and/or the second wheel 500a. In at least one example embodiment, the discharge device 1710 can be included on or within the holders 1220 (see FIGS. 13C, 13F and 17) to at least partially assist in discharging the stacks 155 from the holders 1220 at the first unloading location 190. In at least one example embodiment, the discharge device 1710 is the piston 528, which may operate in a manner that is the same as the embodiment of the piston 528 shown in at least FIGS. 10B and 10C, or the piston 528 may be mechanically moved (by a mechanism other than the rod 735), where a solenoid, a valve, a piezoelectric device, a spring, a magnet, a motor, a pneumatic and/or hydraulic device provides motion to the piston 528, with a direction of movement of the piston 528 that is the same as the piston 528 of the system 100 in FIGS. 1-12 (see FIGS. 10A and 11A in particular). In at least one example embodiment, the discharge device 1710 may be a mechanism or a device that does not include the piston 528, or the discharge device 1710 may be in addition to the piston 528. In at least one example embodiment, the discharge device 1710 includes at least one of a solenoid-activated device, a spring or spring-loaded device, an air-ejection port, a pneumatic or hydraulic device, an arm, a robotic arm, a robot, or a robotically or remote-controlled element, etc., that at least partially assists in separating the stack 155 from a surface that the stack 155 is seated on. Other embodiments of the discharge device 1710 are contemplated.

In at least one example embodiment, the first wheel 500 has a larger diameter, relative to the second wheel 500a. Therefore, in at least one example embodiment, each one of the cutouts 510 of the first wheel 500 moves at both a rate of speed (movement through space) and a rotational speed (revolutions per unit of time) that is slower relative to a rate of speed and a rotational speed of the second cutouts 510 of the second wheel 500. In at least one example embodiment, a slower movement of the stacks 1655 on the first wheel 500 allows a potentially better opportunity for an inspection, removal and/or adjustment (re-orientation, etc.) of the consumer products 105 and/or the stacks 155, prior to the stacks 155 being discharged at the third unloading location 1700. In at least one example embodiment, the consumer products 105 and/or the stacks 155 are inspected, removed and/or adjusted (re-oriented, etc.) on the second wheel 500a, or on both the first wheel 500 and the second wheel 500a.

In at least one example embodiment, the first wheel 500 and the second wheel 500a are a same diameter and rotate at a same speed. In at least one example embodiment, the second wheel 500a has a larger diameter and the cutouts 510 rotate at a slower speed relative to the cutouts 510 of the first wheel 500. In at least one example embodiment, the second wheel 500a is located on the other side 1730 of the first wheel 500 (FIG. 17), or the second wheel 500a is located on a side of the first wheel 500 that is opposite that of the feed tray 130, where a size, a speed of movement and a location of the first wheel 500 and the second wheel 500a may impact an inspection strategy for the stacks 155 within the system 100a. In at least one example embodiment, the system 100a does not include the second wheel 500a, and instead the first wheel 500 discharges the stacks 155 directly onto the second conveyor 180, as described in conjunction with the system 100 of FIG. 1.

As shown in at least FIG. 18, in at least one example embodiment, the first conveyor 110 is angled at an angle of inclination 1800 to assist the consumer products 105 in traveling along the first conveyor 110. In at least one example embodiment, the angle of inclination 1800 is between about 5 degrees and about 35 degrees. In at least one example embodiment, the angle of inclination 1800 is between about 10 degrees and about 25 degrees. In at least one example embodiment, the angle of inclination 1800 is about 15 degrees. In at least one example embodiment, the at least one processor 1410 causes the one or more motors 132 to operate functions of the first conveyor 110 that may include setting and adjust the angle of inclination 1800 in conjunction with vibrating the first conveyor 110 and/or operating the belt 142.

In at least one example embodiment, and as shown in at least FIG. 18, the rails 1635 of the feed tray 130 and/or the rails 125 and inner rails 1610 of the first conveyor 110 define the chutes (“travel paths”) 200 that include a first elbow 1810 and a second elbow 1820 which help accelerate the consumer products 105 from the first conveyor 110 onto the first wheel 500. In at least one example embodiment, an angle of curvature of the first elbow 1810 and the second elbow 1820 can vary, just as an incline of the midsection of the feed tray 130 may vary, to adjust a rate of movement of the consumer products 105 that are loaded into the cutouts 510 of the first wheel 500.

It should be understood that the configuration and any of the elements of the system 100 of FIG. 1 can be included and/or be interchangeable with the configuration and any elements of the system 100a of FIG. 16. For instance, and in at least one example embodiment, any of the elements of the first conveyor 110, the feed tray 130, the first wheel 500, the housing 550 of the first wheel 500, the heat tunnel 175 and/or the second conveyor 180 of the system 100 of FIG. 1 may be combined with or used in lieu of any of the elements of the first conveyor 110, the feed tray 130, the first wheel 500, the second wheel 500a, the first housing 550a and the second housing 550b of the system 100a of FIG. 16, or vice versa. As a further example, and in at least one example embodiment, the system 100 of FIG. 1 can include the second wheel 500a of the system 100a of FIG. 16, or the first conveyor 110 of the system 100 of FIG. 1 can incline as in the first conveyor 110 shown in FIG. 18. In at least one example embodiment, the user control device 150, the one or more user control devices 1240 and/or the user control arrangement 1400 (FIG. 14) can be used to control the system 100a of FIG. 16 in the same manner as in the system 100 of FIG. 1, and the at least one processor 1410 (FIG. 14) of the user control arrangement 1400 can be used to control a movement, timing and general function of any of the elements of the system 100a of FIG. 16, in a same manner as described in association with the system 100 of FIG. 1. Other ways or combining the system 100 of FIG. 1 (or elements of the system 100) with the system 100a of FIG. 16 (or elements of the system 100a), and other ways of using the user control arrangement 1400 to control the systems 100/100a, are contemplated.

FIGS. 22 and 23 are illustrations of the consumer product 105, in accordance with at least one example embodiment.

In at least one example embodiment, the consumer product 105 includes a canister (can, or container). In at least one example embodiment, the canister is cylindrically-shaped. In at least one example embodiment, the consumer product 105 includes a canister with a base 2200 and a lid 2210 (FIG. 22). In at least one example embodiment, and as described herein, the elevation increase 480 between successive outlets 400 of the chutes 200 of the feed tray 130 (see FIGS. 4B and 20) are equal to the height 2220 of the consumer product 105.

In at least one example embodiment, the consumer product 105 includes a canister that contains an oral product. In at least one example embodiment, the oral product may be the oral product previously described.

In at least one example embodiment, the lower surface 2310 of the base 2200 of the consumer product 105 defines a recessed area 2300 (FIG. 23). In at least one example embodiment, the recessed area 2600 includes an annular wall 2320 and an inset end-wall 2330. In at least one example embodiment, the lower surface 2310 of the consumer product 105 is seated on the receiving surface 1330 of the holder 1220 of the second conveyor 180, where the insert 1325 can be fitted into the recessed area 2300 to firmly hold the consumer product 105 on the holder (see at least FIG. 13F). In at least one example embodiment, a size and depth of the recessed area 2300 (FIG. 23) and a height of the insert 1325 (FIGS. 13B and 13F) may vary, and be coordinated, to ensure that a lowest of the consumer products 105 on the stack 155 can properly be seated on the receiving surface 1330 of the holder 1220 (FIG. 13F).

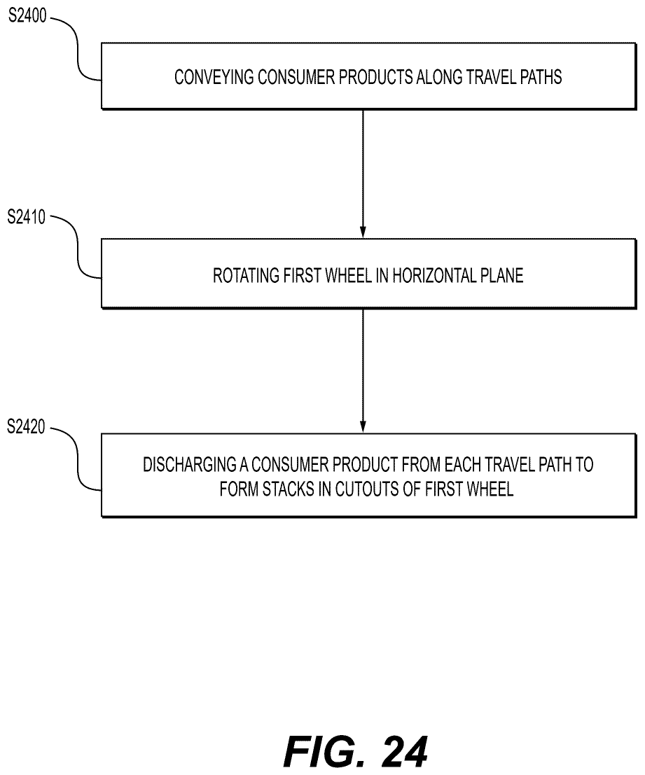

FIG. 24 is a flowchart depicting a method of stacking, in accordance with at least one example embodiment.

In at least one example embodiment, and as shown in step S2400 of FIG. 24, the method includes conveying consumer products along travel paths (see at least the chutes 200 of FIGS. 2, 6 and 16 conveying the consumer products 105). In at least one example embodiment, the travel paths are in side-by-side configuration. In at least one example embodiment, the travel paths each have a discharge point (see at least the discharge points 400 of FIGS. 4B, 6, and 20) that are at unique elevations.

In at least one example embodiment, and as shown in step S2410 of FIG. 24, the method further includes rotating a first wheel (see at least the first wheel 500 of FIGS. 1, 7 and 16) in a horizontal plane. In at least one example embodiment, the first wheel defines cutouts in the periphery of the first wheel (see at least the cutouts 510 in FIGS. 5 and 16).

In at least one example embodiment, and as shown in step S2420 of FIG. 24, the method further includes discharging one of the consumer products from each one of the travel paths into the cutouts of the first wheel, in a successive order as the first wheel rotates, to form stacks in the cutouts (see at least the stacks 155 in FIGS. 8 and 16).

While some example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

We claim:

1. A system, comprising:
a plurality of travel paths for conveying consumer products, the travel paths being in a side-by-side configuration, each one of the plurality of travel paths having a discharge point at a unique elevation; and
a first wheel defining a first set of cutouts around a periphery of the first wheel, the first wheel being configured to rotate in a horizontal plane as each one of the first set of cutouts accepts one of the consumer products from each of the plurality of travel paths, in a successive order as the first set of cutouts pass in front of the discharge points, in order to form stacks of the consumer products in each of the first set of cutouts.

2. The system of claim 1, wherein each one of the plurality of travel paths includes a chute that is at least partially defined by a feed tray, and each of the chutes is in the side-by-side configuration, a distal end of the chutes branching into the discharge points at the unique elevation.

3. The system of claim 1, wherein the first wheel is configured to accept one of the consumer products from each one of the plurality of travel paths at a same time.

4. The system of claim 1, wherein an elevation of each one of the discharge points incrementally increases, from a first discharge point of a first travel path to a last discharge point of a last travel path, of the plurality of travel paths, the first wheel being configured to rotate in a direction that causes each of the first set of cutouts to pass in front of the discharge points in the successive order from the first discharge point to the last discharge point.

5. The system of claim 4, wherein the first wheel is configured to discharge the stacks of the consumer products from each one of the first set of cutouts once a first number of the consumer products in each of the stacks equals a second number of the plurality of travel paths.

6. The system of claim 1, further comprising:
a second conveyor adjacent to the first wheel, the second conveyor including holders, each one of the holders being configured to receive one of the stacks from a respective one of the first set of cutouts of the first wheel at a first unloading location.

7. The system of claim 6, wherein
the second conveyor is configured to transport the stacks in the holders from the first unloading location to a second unloading location, the second conveyor and the holders being configured to discharge the stacks at the second unloading location, and
the second conveyor is configured change an orientation of each one of the holders from an upright orientation to at least one of a tilted orientation or an upside-down orientation at the second unloading location.

8. The system of claim 6, wherein
each one of the holders includes guards that vertically extend from a base of the holder, the guards being configured assist in holding a first stack, of the stacks of the consumer products, on the base, and
the guards are configured to be actuated from a first position to a second position, the first position causing the guards to grip the first stack, the second position causing the guards to be either separated or tilted away from the first stack.

9. The system of claim 1, further comprising:
a second wheel adjacent to the first wheel, the second wheel defining a second set of cutouts around a periphery of the second wheel, the second wheel being configured to rotate in the horizontal plane, the system being configured to discharge each one of the stacks of the consumer products from one of the first set of cutouts to one of the second set of cutouts, and
wherein the first wheel rotates in a first rotational direction that is one of a clockwise or a counter-clockwise direction, and the second wheel rotates in a second rotational direction that is opposite the first rotational direction.

10. The system of claim 1, wherein the first set of cutouts are at least partially conformed to a shape of a side of one of the stacks of the consumer products.

11. The system of claim 1, wherein the first set of cutouts are at least partially conformed to a shape of a side of one of the stacks of the consumer products, each one of the stacks being one of cylindrical in shape or non-cylindrical in shape.

12. The system of claim 6, further comprising:
a heat tunnel at least partially covering the second conveyor, the heat tunnel being configured to apply heat to the stacks as the second conveyor conveys the holders on the second conveyor.

13. The system of claim 1, wherein the first wheel includes
a base structure, the base structure being configured to rotate in the horizontal plane,
an eccentric cam positioned in a central location above the base structure, the eccentric cam being affixed in a stationary position such that the eccentric cam does not rotate with the base structure,
a piston operatively arranged within each one of the cutouts, each one of the pistons being connected to a rod that is supported by and rotated with the base structure,
a bumper on a first end of each one of the rods, the bumper being configured to contact an interior surface of the eccentric cam,
at least one first spring operatively connected to each one of the rods, a distal end of the at least one first spring being connected to the first end of a respective one of the rods, a proximal end of the at least one first spring being connected to a collar, the collar being between the eccentric cam and the first set of cutouts, the at least one first spring being configured to bias a respective one of the rods and pull the rods toward a respective one of the first set of cutouts.

14. The system of claim 13, wherein
an extended portion of the eccentric cam is closer to a first portion of the first set of cutouts relative to a remaining portion of the eccentric cam, the remaining portion of the eccentric cam having a circular shape from an overhead perspective, and
the extended portion is configured to cause the at least one first spring to pull each one of the rods toward a respective one of the cutouts, of the first set of cutouts, such that the piston at least partially extends outward to discharge a respective one of the stacks from the first wheel at the extended portion of the cam.

15. The system of claim 1, wherein
the consumer products include a canister that is filled with a material prior to the consumer products being conveyed by the plurality of travel paths, and
the material includes an oral product.

16. A method of stacking, comprising:
first conveying a plurality of consumer products along a plurality of travel paths, the travel paths being in a side-by-side configuration, each one of the plurality of travel paths having a discharge point at a unique elevation;
first rotating a first wheel in a first horizontal plane, the first wheel being near the discharge points of the plurality of travel paths, the first wheel defining a first set of cutouts around a periphery of the first wheel; and
first discharging one first consumer product, of the plurality of consumer products, from each one of the plurality of travel paths into a respective one of the first set of cutouts, in a successive order as the first wheel rotates, to form stacks of the consumer products in each of the first set of cutouts.

17. The method of claim 16, wherein the first conveying conveys via a chute that is at least partially defined by a feed tray for each one of the plurality of travel paths, each of the chutes being in the side-by-side configuration, a distal end of the chutes branching into the discharge points at the unique elevation.

18. The method of claim 16, wherein
the first discharging discharges such that an elevation of each one of the discharge points incrementally increases, from a first discharge point of a first travel path to a last discharge point of a last travel path, of the plurality of travel paths, and
the rotating rotates the first wheel in a direction that causes each of the first set of cutouts to pass in front of the discharge points in the successive order from the first discharge point to the last discharge point.

19. The method of claim 16, further comprising:
second discharging each one of the stacks of the consumer products from a respective one of the first set of cutouts of the first wheel into a respective holder, of a plurality of holders, at a first unloading location; and
second conveying the plurality of holders in a first direction towards a second unloading location using a second conveyor, the second conveyor being adjacent to the first wheel.

20. The method of claim 16, further comprising:
second rotating a second wheel in the first horizontal plane, the second wheel being adjacent to the first wheel, the second wheel defining a second set of cutouts around a periphery of the second wheel; and
second discharging each one of the stacks of the consumer products from the first set of cutouts to the second set of cutouts at a second unloading location.
